(19) United States
(12) Patent Application Publication
(10) Pub. No.: US 2001/0055414 A1
(43) Pub. Date: Dec. 27, 2001

(54) System and method for digitally editing a composite image, e.g. a card with the face of a user inserted therein and for surveillance purposes

(76) Inventor: Ico Thieme, Peschiera Borromeo (IT)

Correspondence Address: YOUNG & THOMPSON, 745 SOUTH 23RD STREET 2ND FLOOR, ARLINGTON, VA, 22202

(21) Appl. No.: 09/834,920

(22) Filed: Apr. 16, 2001

(30) Foreign Application Priority Data
Apr. 14, 2000 (EP) PCT/EP00/03389
Nov. 20, 2000 (EP) PCT/EP00/11508

(51) Int. Cl. G06K 9/00; G06K 9/03

(52) U.S. Cl. 382/135; 382/162; 382/309

(57) ABSTRACT

A system and method for digitally editing or printing a composite image, for example a “view” or panorama (4) of a card (3) with a face of a person or subject (6) included in said “view” (4), the system and method allowing a video-camera (18) to carry out taking operations in a free taking field, i.e. with the subject (6) on a “dynamic” background. A cropping of the subject (6) is carried out by operating on two images, i.e. a first virtual image, formed by a “reference background” and a second image, formed by a “background-subject assembly”, and the subject (6) is embedded in the “view” (4) by physically replacing the pixels of the “view” (4) by the pixels defining the subject (6). Thus, no monochromatic backgrounds in the form of curtains and box wall are necessary, and the system housing apparatus can be installed in any desired environment.

A simplified system and method for the digital printing field with a presence sensor are also suggested wherein said presence sensor is in the form of a software operating through the video-camera (18) of the system. Said optical software operated presence sensor also allows the use thereof in a simplified two-image cropping system for the surveillance and safety field.

### FIELD OF THE INVENTION

The present invention relates to a system and method for digitally editing a composite image, e.g. a card with the face of a user inserted therein and for surveillance purposes.

### BACKGROUND OF THE INVENTION

In the present disclosure, the term “subject” will mean the user, for example, the face of the user, to be embedded in a “view” or “panorama” as prestored in the system, for example in a picture postcard, which can be selected by the user from a plurality of prestored cards.

The term “view” or panorama, will mean a prestored background image of the considered composite product, for example the above mentioned picture postcard, reproducing, for example, a seascape or a mountain scenery, view of towns and the like, as it is conventional in picture postcard in general.

The term “background-subject assembly” will mean a background actually present on the rear of the shoulders of a user which is taken by a camera as the subject is taken, for example the face of the user.

The term “taken background” will mean a background which is taken by the camera with a free taking field, i.e. without the presence of the subject.

Finally, the term “reference background” will mean a virtual working background, or a valid background, on which the novel cropping operation according to the invention will be performed.

It should be moreover pointed out that the terms “taken background” and “reference background” or “virtual working background”, are novel concepts according to the present invention.

Several electronic image processing methods and techniques, as well as the related systems, for making multiple-purpose printed image products and are already known in the art.

Such prior methods and systems comprise, for example, methods and systems for making composite cards (as indicated by 3 in FIG. 3), comprising, for example, a view or panorama (indicated by 4 in FIG. 3) having the subject inserted therein, for example a user face (indicated by 6 in FIG. 3), arranged at one or more preset positions, for example at the left, center or right, with an optional arrangement of text or caption parts (as indicated by 32 in FIG. 3) and so on, and methods and systems for respectively making one of the so-called “special products” such as greeting cards, photo-cards, stickers or adhesive labels, visiting cards, and so on.

With reference to the making of composite cards, or cards incorporating a subject therein, reference is herein made to the prior art disclosed in the U.S. Pat. Nos. 5,345,313, 5,577,179 and 5,469,536, documents all issued to Arthur M. Blank, which are incorporated therein by reference, and of which the last two are “continuations-in-part” of the first.

In this patents, for separating a subject from a background-subject assembly, which operation is herein called “cropping”, there is used a known “chroma-key” method which, on one side, requires a monochromatic background on the rear of the shoulders of the subject inside a closed booth assembly (U.S. Pat. No. 5,577,179, FIG. 1) or outside thereof (U.S. Pat. No. 5,345,313, FIG. 1) and, on the other side, provides to crop the subject by operating on a single image, or on the “background-subject assembly”.

The monochromatic backgrounds on the rear of the subject shoulders, included the grid backgrounds having like dot patterns in individual mesh arrangements thereof (U.S. Pat. No. 5,345,313, FIG. 2) form “static backgrounds”, which cannot be varied.

According to the mentioned chroma-key method, the monochromatic background must have a size greater than that of the subject, and, in the cropping operation, all the pixels having a preset color and similar colors would be removed from the background, with a consequent danger of also removing subject parts having said preset color or similar colors, for example parts of a blue shirt, in the case of a blue reference color. Accordingly, the composite card could further include undesired and anaesthetic “holes” as well as subject contour unevennesses.

In U.S. Pat. No. 5,345,313, the contour of a subject, for example of the figure of a person, has a first shade, and the background-subject assembly (taken with a monochromatic or outer “static background”) has a second shade. According to the “chroma-key” method, based on the difference between the two shades and a preset shade difference, the system processor will focalize the edges of the subject and remove background portions arranged outside the subject edge or contour. The thus cropped subject can be then combined with a “view or panorama background” preselected by the user so as to form a composite picture card (indicated by 1 in FIG. 3) as above illustrated.

In the modified embodiment including a grid background, said background is stored in the system.

The method and related apparatus disclosed by the U.S. Pat. No. 5,577,179 document provide to store the digital image of a subject, and a background-subject assembly, as well as at least a further view, which can be selected from a plurality of prestored views or panoramas, which view comprises several components, in a tridmensional or layered pattern. The subject contour has a first shade and the background behind the shoulders of the subject has a second monochromatic shade.

As in U.S. Pat. No. 5,345,313, the “background-subject” assembly is cropped to successively remove background portions outside the subject contour. Then, after the cropping operation, the subject can be combined with the selected view thereby providing the desired composite image or card. Means are moreover provided for making the introduction of the subject into the view much more “realistic”.

More specifically, according to the U.S. Pat. No. 5,577,179 patent, to components of the preselected view, related X-Y plane locations, as well as a value defining their positions in one of a plurality of layers forming the Z-dimension of the image are assigned. Moreover, to the subject being incorporated into the view, a value defining its location in at least one of said layers is assigned. For processing the image an image processing method with multiple-layer arrays or matrix patterns, or a “transparency” processing method, which likewise requires the use of a monochromatic background which, as in the case of a grid background, will form invariable monochromatic, i.e. “static” backgrounds are used.

In addition to using the method disclosed by the U.S. Pat. No. 5,577,179 document, the U.S. Pat. No. 5,469,536 patent discloses to selectively assign to a mask the colors of a digital or video image and, more specifically, of the full image or of a selected area of said image. The color processing can be then carried out on the colors of the images defined by the mask. The latter can be used either with the overall image, a selected area thereof, or with subjects.

Finally, it is pointed out that, as thereinabove stated, the chroma-key method does not provide to use either a “background taken without subject” or a “reference background” as shown, for an easy understanding, in FIGS. 4B and 4B1, exclusively for facilitating a comparing with the teachings of the present invention. It should be moreover pointed out that the chroma-key method does not allow to use multi-chromatic backgrounds, or backgrounds holding, in addition to the subject, other figures, possibly randomly distributed, as those which would be encountered, for example, in a case of take backgrounds, according to the invention (FIG. 5B), taken by a camera without booth assemblies, i.e. having a free-standing taking field, which “taken backgrounds” (FIG. 5B) can be accordingly defined as “dynamic backgrounds”.

WO 93/17.517 combines the teachings of both U.S. Pat. No. 5,345,313 and U.S. Pat. No. 5,577,179 documents.

The above mentioned methods and related processing and cropping methods have a lot of drawbacks and disadvantages, both with “static” backgrounds in a booth assembly and with “static” backgrounds in an outside environment.

A main disadvantage is that the booth assemblies will require a comparatively large installation surface, usually of about 2 m², which, added to the area necessary for the circulating persons, likewise of about 2 m², will provide to an overall installation surface of about 4 m².

Accordingly, the installation of the above mentioned closed booth assemblies can be made, and is justified, exclusively at large surface locations, for example at rail stations, subway passages, large motor way restaurants and so on. In this connection it should be moreover considered out that current booth assembly are not monitored by personnel. Accordingly, in a failure event, the apparatus will remain unused up to a subsequent inspection by a servicing operator, according to a preset monitoring rate. The economic damage would be self-evident. The technical servicing of the mentioned booth assembly, furthermore, is conventionally performed by a technical operator staff, whereas the periodic servicing, i.e. the servicing for removing the paid money and replenishing the consume materials, is carried out by those persons or companies who have bought or contracted the booth assembly.

Considering the comparatively large size of prior booth assemblies, it would not be possible to use them in conventional business places and stores of comparatively small size, such as photographic material stores, bars, stationery shops, tobacco shops and so on.

A further disadvantage of current booths of the above mentioned type is that each booth is provided for making a single product. Accordingly, in order to provide several products, a lot of booth assemblies are frequently installed one near the other, possibly with different technical servicing and periodic replenishing networks.

The size problem is further compounded in systems with an outer monochromatic background, either with or without modular dot arrangements (U.S. Pat. No. 5,343,313). This background would have a size of several m² and, moreover, would require a distance of several meters from the system casing, thereby the above mentioned apparatus can practically be used exclusively in exposure rooms or the like.

The U.S. Pat. No. 5,764,306 discloses a real-time method of digitally altering a live video data stream to remove portions of the original image and substitute elements to create a new image without using traditional blue screen techniques.

The requirement of operating in real-time will only furnish a mediocre quality of the produced composite images. Another shortcoming is to be seen in the limitation of the used colors. For example, for achieving better results the operator should not be wearing colors that correspond directly to colors that are directly posterior in the reference view.

Another limitation is to be seen in the fact that the reference background should be substantially static and with a sufficient and stable light source.

It is also stated that the suggested method allows for easy adjustments by the operator and that the software also allows for automatic adjustment. However, said U.S. Pat. No. 5,764,306 is silent about how this should occur.

The U.S. Pat. No. 4,891,660 A discloses an automatic photographic system and frame dispenser including proximity detector means for detecting the proximity of one or more persons as well as means responsive to the detected presence of one or more persons to produce a recorded announcement orally inviting such persons to utilize the equipment.

The WO 99 55 995 A discloses an access control system in which a presence sensor is mounted to detect the presence of a person within the system cubicle.

The EP0 626 611 A discloses a photographing box in which if any trouble takes place in any place in the photographic system, the trouble information is sent out from a controller to a phone line and is read into a host machine. Said trouble information could also be sent out through a radio machine and received by another radio machine from which the information is read into the host machine.

After a lot of tests under very different conditions the inventor has also found that

the known presence sensors operating with the microwave technology could affect the reliability of the systems incorporating said sensors,

that it would be desirable to further reduce the operating time of the suggested system, and

that it would be desirable to also use the suggested basic concepts in fields different from the digital printing field.

### SUMMARY OF THE INVENTION

Accordingly, the aim of the present invention is to provide an improved system and method, of the above mentioned type, free of the drawbacks and disadvantages of the prior art and adapted to operate without requiring prior monochromatic or “static” backgrounds, while using a camera free taking or shooting field.

Within the scope of the above mentioned aim, it is an object of the present invention to provide an improved system and method specifically designed for making, in addition to the above mentioned composite card, upon selection, so-called “special products”, such as visiting cards, greeting cards, stickers or adhesive labels, photo-cards and so on.

Another object of the present invention is to suggest an improved system and method the basic concepts of which may also be used in fields different from the digital printing field, for example in the spatial surveillance or safety field.

Yet another object of the present invention is to suggest a simplified and quicker managing software with respect to the basic embodiment.

Another object of the present invention is to suggest a new way to substitute the known presence microwave sensor with a new kind of presence sensors.

According to the aspects of the present invention, the above mentioned aim and objects are achieved by systems and methods having the features claimed in claims 1, 11, 33, 34, 39 and 40.

Further advantages and embodiments are defined by further claims. A description of said claims is here omitted for avoiding repetitions.

The system and method according to the invention provide a plurality of important advantages. At first, it is not necessary to use a monochromatic or “static” background, thereby it would not be necessary to assemble the apparatus according to the invention in a closed and large sized booth provided with a background-wall or monochromatic curtain and, accordingly, it will allow to assemble the overall components of the inventive system in a column casing, of a comparatively small cross section, thereby the assembling surface of the apparatus can be drastically reduced, for example to 0.5 m², or less, whereas also the person circulating surface will substantially correspond to about 0.5 m²; thus the overall surface necessary for operatively assembling the inventive apparatus will be of the of the order of about 1 m² or less. This great reduction of the assembling surface, corresponding to about a ¼ of the surface of a prior single closed booth, will advantageously allow the system or apparatus according to the invention to be installed substantially in any commercial places or conventional stores and, moreover, either inside the latter or immediately outside thereof at covered regions, for example, in a case of a store, in an arcade way, or, in a gallery store and so on.

This advantageous “non-use” of static backgrounds on the rear of the subject shoulders, both in an outside environment and as a background wall or curtain in a booth assembly, would allow to eliminate the prior “hole” drawback, any inaccurate boundaries of the subject in prior composite cards, and the large sized and expensive booth assemblies.

Furthermore, a continuously present shopkeeper, or other store personnel, would allow to perform the money removal and consume material replenishing operations, at the end of a working day, and to immediately intervene, e.g. upon a visual and/or acoustical signaling by the apparatus, for example by communication means such as transmitting/receiving radio systems at the shopkeeper cash or location, to immediately recover to a good operating situation from a lot of possible technical problems, thereby greatly reducing the servicing cost and eliminating any dead inoperative times of the apparatus.

Moreover, owing to the inventive method and a continuous presence of the shopkeeper, it would be also advantageously possible to provide, upon selection, in addition to the mentioned composite cards, several “special products” as thereinabove mentioned.

Yet another advantage is that it would be possible, by using a modem and phone arrangement, to directly send to acquaintances and friends, for example, cards or greeting cards for a lot of events, via Internet, by simply introducing the required money for this service. Yet another important advantage is that it would be also possible, on one side, owing to a potential great diffusion of the inventive apparatus and, on the other side, the possibility of making, by the same apparatus, several composite cards and “special products”, to greatly reduce the making cost while increasing the economic gains of an installed apparatus.

To the above it should be moreover added that, considering the installation of the inventive apparatus in “unanonimous” places, i.e. in well zonally defined places having a well established client pattern, the apparatus according to the present invention can moreover operate as an efficient advertising means, including advertising messages or banners, for example related to local products and/or shops, such as restaurants, travel agencies, insurance companies, banks and the like, and this in a simple manner, in “temporary” video images, or in a user talking form, for example for a preset time period. This, likewise, will contribute to increasing the profitably of the apparatus according to the invention. A further advantageous aspect is that the users of a store installed apparatus would frequently contribute, as they are present at these places, to also increasing selling of other products offered by the store.

Yet another advantage, with respect to the making cost, is that the novel system or apparatus including said system, would be much more unexpensive than conventional apparatus and booth assemblies, since the booth assembly and related background-wall or monochromatic curtain can be actually omitted. A further advantage is to be seen in the fact that the optical detection of intruder presence by software, which can be autonomously performed by a preferred embodiment of the suggested system, allows to fully eliminate both the prior detector, per se, i.e. made as a hardware component, and the drawbacks related to the operation thereof.

In fact, a reduced number of components to be assembled and wired, is required, thereby providing a greater operation reliability, less jamming or idling of the system, as well as a less cost thereof.

Another important advantage is that the provision of a novel algorithm has allowed an indirect and immediate development of the software in fields different from the digital printing of a composite image, for example in the spatial surveillance and safety field.

Yet another advantage is that a preferred embodiment of the proposed software can also be used for broadening the printed article types to be obtained.

### BRIEF DESCRIPTION OF THE DRAWINGS

Further features, advantages and details of the improved system and method according to the present invention will become more apparent hereinafter from the following disclosure of preferred embodiments thereof, which are given by way of a merely indicative example, with reference to the accompanying drawings, where:

FIG. 1 illustrates a prior closed booth assembly—or a booth which can be closed by a curtain—,for making composite cards;

FIG. 1A illustrates a prior apparatus for introducing into a “view” or panorama a “subject” with an outer background on the rear of the shoulders of said subject;

FIG. 2 is a schematic general block diagram of the system according to the present invention, shown by a dash and double-dots frame and including a first electronic component assembly, known per se, shown by a dash and single-point frame, and an additional electronic component assembly, shown by a dashed frame;

FIG. 3 illustrates a prior exemplary composite card, i.e. including in a view of panorama, the face of a user at a preset position, in the shown example at the right, which can be produced according to the prior art and by the method and system according to the present invention;

FIG. 4 is a farther schematic block diagram showing a prior “layered” method for making composite cards;

FIGS. 4A to 4E schematically show a “view” or panorama and the steps for making a composite card according to the prior chroma-key method, in a case of using a blue color for the monochromatic background, in which, the steps 4B and 4B1, which are not actually provided, are anyhow indicated in order to facilitate a comparing with the steps according to the invention;

FIG. 5 is a further schematic block diagram illustrating the steps for making a composite card according to the teachings of the invention;

FIGS. 5A to 5E schematically show, by way of a merely indicative example, a “view” or panorama and the steps for making a composite card by the system and method according to the present invention;

FIG. 6 is a further schematic block diagram illustrating the steps for producing a card like that of FIG. 5, to which a further step for additionally producing “special products” is added;

FIG. 7 is a perspective view illustrating an exemplary embodiment of a column casing or housing including the system according to the invention;

FIG. 8 is a side elevation view of the apparatus shown in FIG. 7;

FIG. 9 conceptually shows an exchange patters for exchanging messages between two operating modules by the Registry assembly of the computer included in the system;

FIG. 10 conceptually shows the files provided for forming the “scratchpad time queue”, in the considered embodiment six files, in which is copied that “reference background” to start the system which, in this embodiment, corresponds to the “taken” background”;

FIG. 11 is an exemplary view illustrating the backward sliding principle of the backgrounds for carrying out the self-updating step of the “reference background”;

FIG. 12 shows, by way of an example, the principle of a background interpolating function as applied on a “twin” image of the “background-subject assembly” image, for updating the “reference background” as said “background-subject assembly” image is taken, and for suppressing any transient noises from the “taken backgrounds”;

FIG. 13 is analogous to FIG. 12 and shows a case in which the noise or aliasing on the image in BackO, i.e. in the “reference background” is represented by the subject itself,

FIG. 13A schematically illustrates, on an enlarged scale, a virtual “reference background” according to the invention;

FIG. 14 is a schematic view illustrating a manner for preventing aliasing or noise defects from being transferred into the “reference background”, or into the BackO image;

FIG. 15 illustrates the concept of a projection of an isoarea from foreground (background with subject) to background (reference background);

FIG. 16 illustrates the concept for eliminating “orphan” pixels in a multiple function processing;

FIG. 17 is a schematic view illustrating a boolean comparing operation;

FIG. 18 is a schematic view illustrating a KillForeOrphan ( ) and a KillBackOrphan ( ) operating functions;

FIG. 19 is a schematic view illustrating a SeekAreeOrphan ( ) and a SeekAreeFore ( ) operating functions;

FIG. 20 is a schematic view illustrating the filing or trimming function ( );

FIG. 21 is a further schematic view illustrating a function for merging the “subject” into the “view” or panorama;

FIG. 22 is a further schematic view illustrating a function for adding written text or wordings in Overlay;

FIGS. 23, 24, 25 and 26 illustrate printing layouts for some “special products”;

FIG. 27 illustrates a flow chart of a starting program;

FIGS. 28, 28A and 28B illustrate subsequent portions of a flow chart of a user managing procedure or routine;

FIGS. 29 and 29A illustrate a flow chart of a “special products” managing routine;

FIG. 30 illustrates a post-processing flow chart of “photo-cards and stickers”;

FIG. 31 illustrates a flow chart of a “new payment” routine or procedure;

FIG. 32 illustrates a flow chart of a “taking or shooting performing” routine;

FIG. 33 illustrates a flow chart of a “printing material request” routine;

FIGS. 34 and 34A illustrate two consecutive portions of a post-processing routine for processing “visiting cards”,

FIG. 35 illustrates a typical sensitivity lobe of a microwave sensor;

FIG. 36 illustrates the system video camera overshooting field, as tending to infinite;

FIG. 37 illustrates the parallax phenomenon related to the use of the mixed detection technique provided in the previous embodiment;

FIG. 38 illustrates the background updating or refreshment at the moment of the BackGenerator, and the building of a “virtual reference background” (5B1);

FIG. 39 illustrates as a detail the composition of the “virtual background” (5B1);

FIG. 40 illustrates the new cycle for eliminating the backgrounds (5B1);

FIG. 41 is a schematic general block diagram of a simplified surveillance and safety or security system according to the present invention;

FIG. 42 illustrates the inside of a store being surveilled or monitored by the surveillance and safety or security system according to the present invention;

FIG. 43 illustrates a monitoring and surveilling room of the store shown in FIG. 42, according to the prior art;

FIG. 44 illustrates a “sample image” which can be stored in the system as a “reference background” or as a “first image”;

FIG. 45 illustrates an image as cyclically provided by the video-camera, or “second image” and which is automatically compared with the reference image or “first image” of FIG. 44;

FIG. 46 illustrates a result of an analysis between the “second image” and “first image”, which, after having performed the cropping, shows the presence of remaining areas indicating a presence of an intruder;

FIG. 47 shows a color changing of the surveillance monitor screen and the displaying thereon of the remaining or residual areas after the cropping, or of the intruder; and

FIG. 48 shows a flow chart illustrating the operation mode of the surveillance and safety system and method according to the present invention.

### DESCRIPTION OF THE PREFERRED EMBODIMENTS

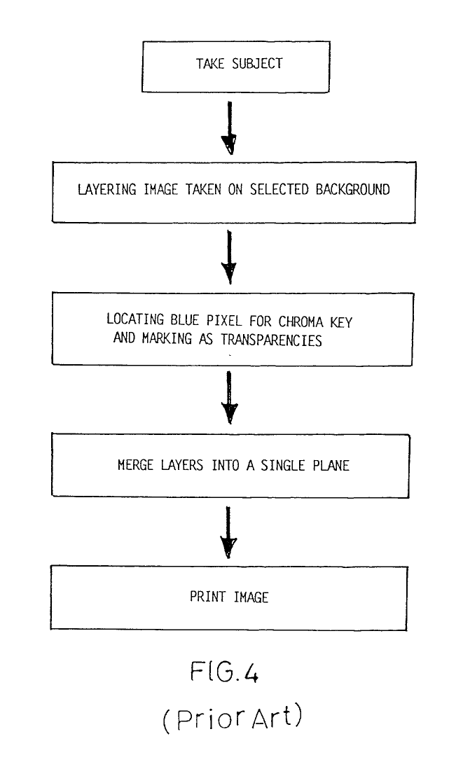

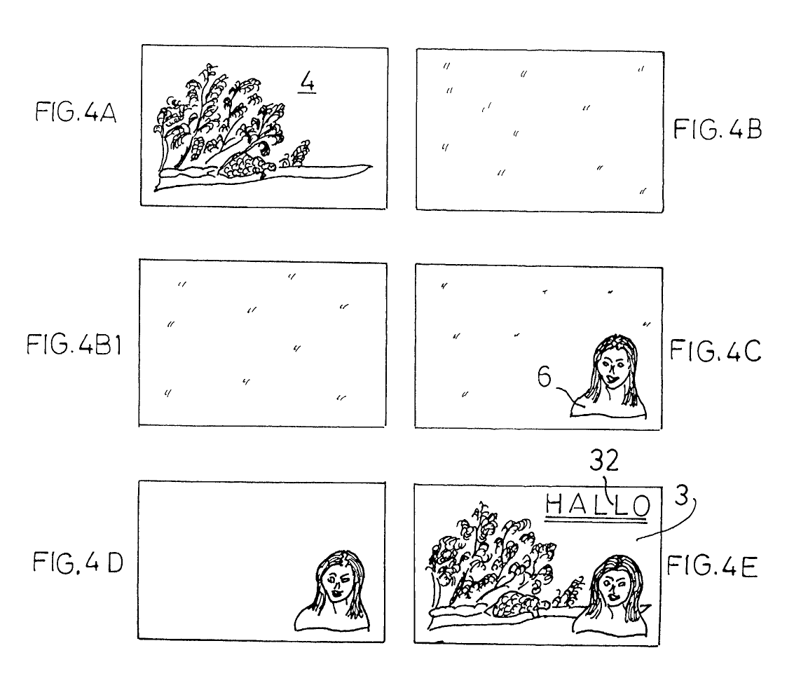

As previously stated in the introductory part, the prior chroma-key method substantially operates, on a side, on pixels having a color similar to the monochromatic basic background color and, on the other side, on pixels of all the other colors of the background-subject assembly, i.e. on pixels of a single image or “background-subject assembly”, see FIG. 4C.

Accordingly, this is a cropping method performed on a single image or “mono-image” with the limitation of requiring a “monochromatic or static background or bottom”, either inside (with a “booth”) or outside (of a comparatively large size), and with a possible presence of holes or contour unevennesses of the subject, due to the presence, in said subject, of parts having the same color as the monochromatic background.

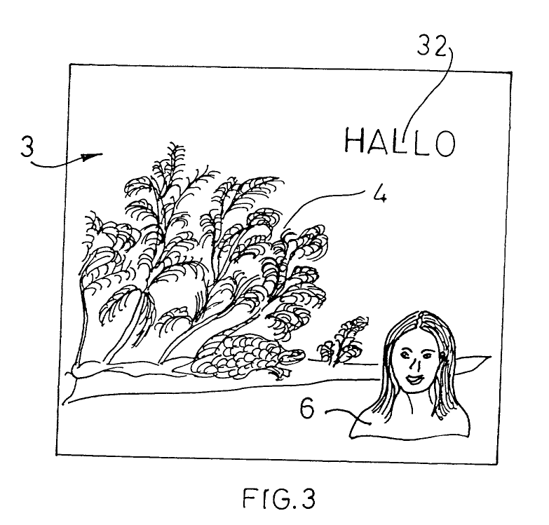

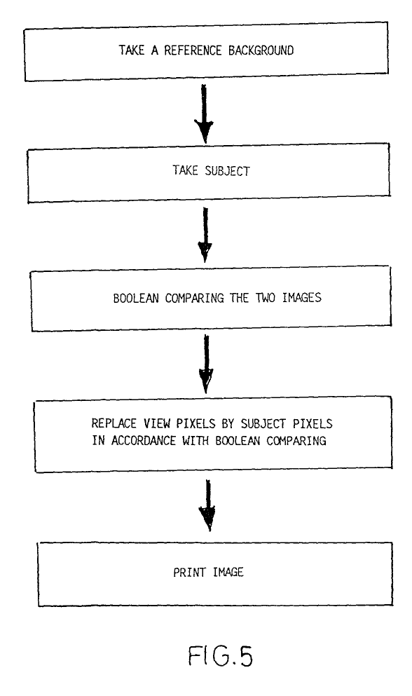

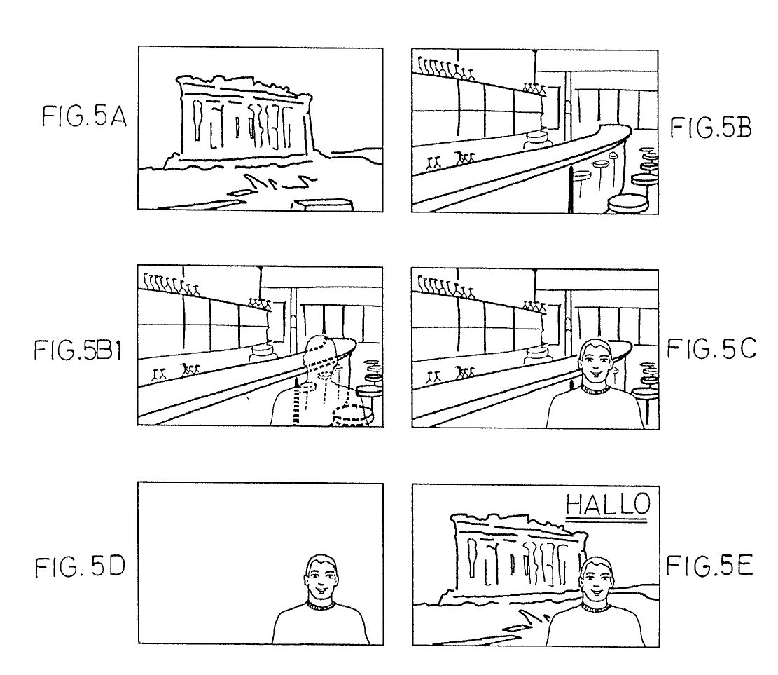

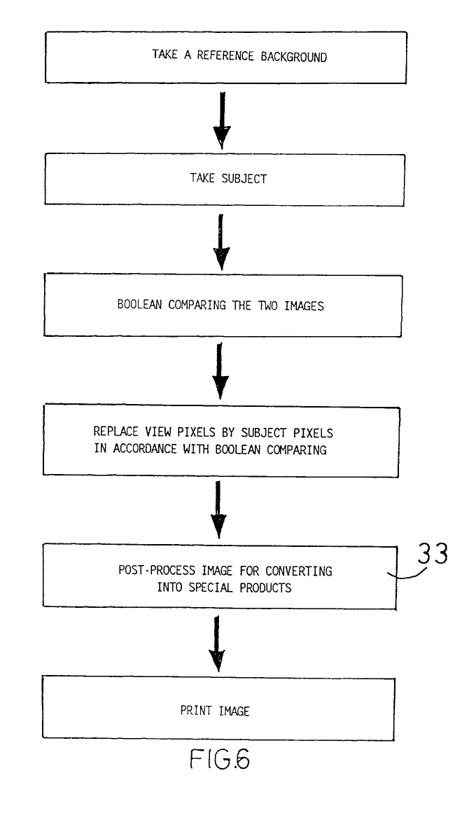

As it will be disclosed in a more detailed manner hereinafter, by the system, operating architecture and method according to the present invention, which does require not any “monochromatic” background, the cropping of the subject 6 (FIG. 3) is, on the contrary, performed by a different method, by operating, on one side, on the pixels of a “dynamic” “reference background” formed in a virtual manner (FIG. 5B1), which can be obtained by a sequence of “taken backgrounds” (FIG. 5B), and, on the other side, on the pixels of the image of the “background-subject assembly” (FIG. 5C) which can optionally comprise other figures or objects taken on the background, which latter is potentially continuously varying, (for example a shop furniture assembly). The novel cropping method according to the present invention can be accordingly defined as a “two images” cropping method.

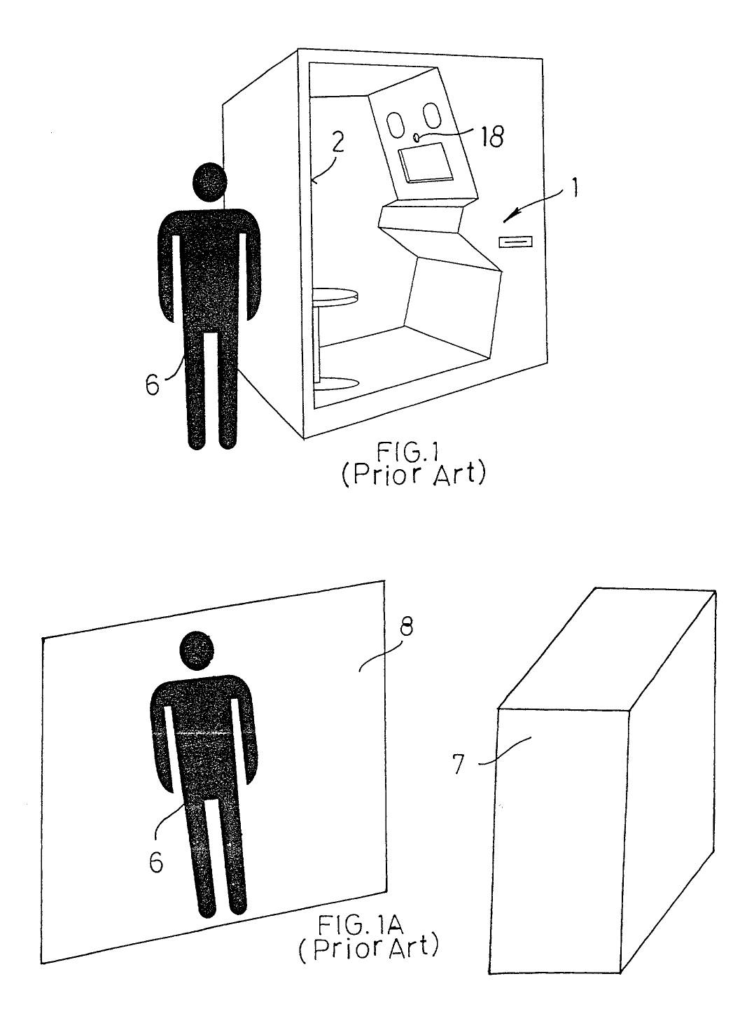

FIG. 1 shows a closed booth 1 of comparatively large size, said booth comprising a bottom or background monochromatic wall 2 and a system using the “chroma-key” method for making a composite card 3 which, in the exemplary embodiment shown in FIG. 3, is constituted by a “view” 4 with a tropical seascape, as well as the face 6 of the user, or of the subject.

FIG. 1A shows the prior system including in a parallelepiped casing 7 the related apparatus as well as an outer monochromatic background 8, in front of which is located the subject 6 which, in this example, will be taken as a full “figure” image.

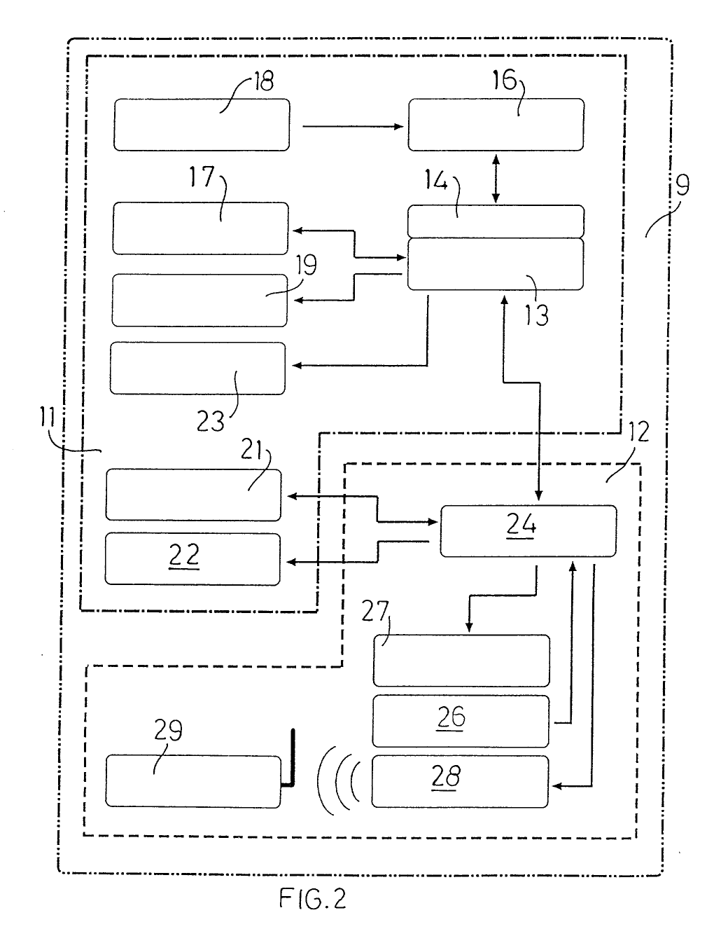

With reference to FIG. 2, the system according to the present invention comprises a per se known component assembly 11 and a further auxiliary component assembly 12, which cooperate with prior or known components and with the shown software operating modules or programs, to carry out the inventive operating method, as hereinafter further disclosed, to perform the inventive novel process and cropping procedure.

More specifically, the per se known component assembly 11 comprises:

a PC 13 (and the related processor or multiprocessor, for example Intel Pentium II 450 MHz®, and store 14 (for example a 128 Mb RAM),

a video acquisition board 16 having a 720×576 pixel resolution (for example Euresy “Piccolo”®,

a monitor 17 (for example a Microtouch® touch screen),

a 18 PAL videocamera or a Y/C having 480 horizontal TV lines (for example Pulmix PEC 3010®),

a printer 19, for example an Epson Stilus Color 900®),

a banknote or money read-out device 21, such as an OTR “Global Bill Acceptor®, for example in the form of a coin reading device and/or in the form of credit cart reader and/or prepaid card reader and so on,

an optional illuminating or lighting device 22 as well as,

an optional loudspeaker 23, where the specifications shown in brackets indicate components suitable for performing the invention, likewise to the operating module or program assembly which will be further disclosed hereinafter together with their related functions, whereas the auxiliary or integrating component assembly 7 comprises:

an outer PLC 24 (for example a Mitsubishi FX2N® with a serial board), and

a presence sensor 26 (for example an Orion® of a microwave type).

In a first variation of the above mentioned auxiliary components 12 is further included a directional LED 27, which operates, as it is energized or blinks, for prompting the user to automatically turn his/her face toward said LED, thereby providing a proper framing of the user face in the video-camera 18.

In a further variation, said assembly 12 further comprises communicating means, for example a radio TX or transmitter 28 and a radio receiver or RX 29, said RX being, for example, arranged near a cash station or main place of the shopkeeper.

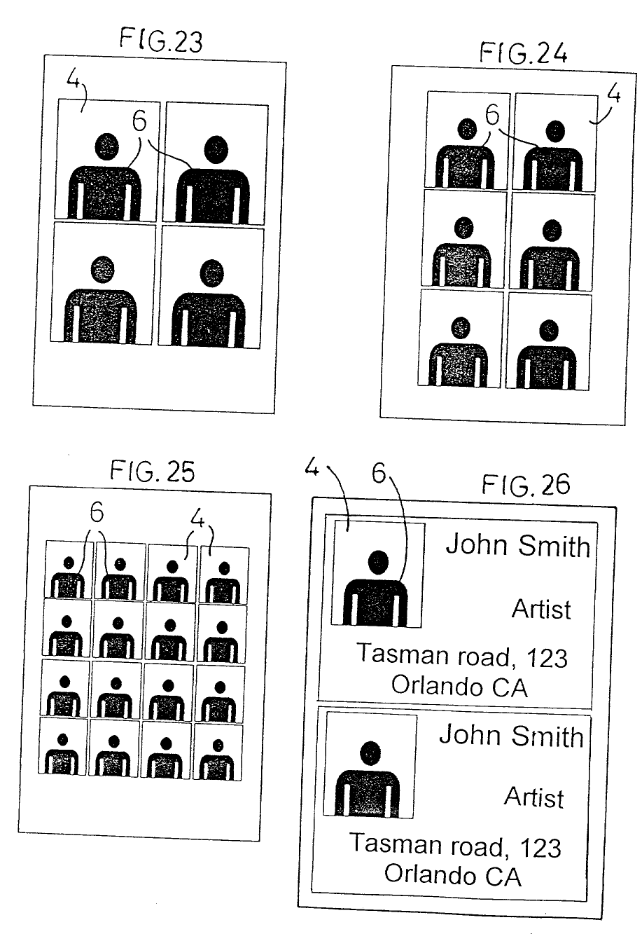

The printer is indicated by the reference number 19. The system for printing both cards and “special product” cards, can comprise a single printer and associated feeding devices for feeding the paper media to be printed upon, as shown in FIGS. 23 to 26, or said system can also comprise a plurality of printers, one for each product, in a not herein shown manner. This features and details, on the other hand, are not further herein illustrated since they would be self-evident to one skilled in the art, and since they are components easily available on the market.

With respect to the software operating modules or programs, which will be disclosed with reference to the preferred embodiment, they including, in part, programs applying substantially known methods and, in part, programs allowing to practically carry out the operating teachings and method according to the invention as it will be disclosed in a more detailed manner hereinafter.

For developing the novel “two image” cropping method, which does not use any monochromatic walls or background curtains, the inventor has at first considered the following two basic aspects:

a) two images, to be equal, must be provided with equal color isoareas, arranged in a like manner, and

b) if in one image (Figure C) of two images (FIG. 5B1 and 5C) which should be equal, would be instead present different chromatic regions (for example due to the presence of the subject or face of the user 6), then this would mean that a detectable outer element (the subject 6 in FIG. 5C) has introduced a perturbation or noise in the pixel pattern related to the subject image (background-subject assembly of FIG. 5C) with respect to the pixel pattern of the other image (reference background, FIG. 5B1, made as hereinafter shown).

Considering the above discussed aspects, to properly perform the cropping method according to the present invention, a differential analysis between the two images is performed at first, see FIGS. 5C and FIG. 5B1, based on a composition of an aggregating set of pixels on a chromatic and dimensional base. Thus, according to the teachings of the present invention, by a boolean comparing, a “second image”, of a real type, (FIG. 5C), or “background-subject assembly” is subtracted from a virtually formed working or valid “first image”, (FIG. 5B1) or “reference background”, which will be virtually formed as thereinbelow disclosed. Accordingly, by the mentioned subtracting operation, the perturbation indicative regions or areas, i.e., in this case, the subject or face of the user 6 as taken by the video-camera 18 (FIG. 5D) are identified.

According to the invention, one tries to identify and suppress the common areas of two images (FIG. 5B1 and FIG. 5C), to obtain as a result of said suppressing or “cropping” method, exclusively those areas or regions (FIG. 5D) which would be exclusively present in the “background-subject assembly” image (FIG. 5C) as formed by the user controlled video-camera 18.

Thus, it would be possible to carry out the above mentioned procedure and method in an efficient manner by operating, for example, in a Visual C++® Microsoft® development environment, since the C++ language exploits the pointer arithmetic, i.e. a programming method directly referring to the hardware of the processor and RAM, thereby directly controlling the data by symbolic “pointers” thereof data, without the need of carrying out copies to bring it again into the program, or to process and recover it to the system. Thus, two important advantages, and more specifically a high operating speed and a direct control of the hardware data, are thereby obtained.

The basic software operating modules or programs are, in a preferred embodiment, as follows:

Module A: The Mask.exe (Written by Director by Macromedia®

This is the system-user interface.

It displays on the screen or monitor 17, the different options which can be selected by the user, communicates to the system said user selected options, by pressing the plurality of controlling areas or virtual keypads shown on the screen 17.

This program will moreover provide the necessary graphic animations.

More specifically, said system will provide the following operations:

requiring the selection of the language to the user and writing into the Registry the related key;

displaying the amount of money to be introduced by the user;

displaying several options therefrom the user can select;

displaying to the user the “views” or panoramas which are available in the selected option and writing into the Registry the name of the file of the image being selected by the user;

displaying to the user the locating subject options, and writing into said Registry the value corresponding to the selected location;

displaying to the user the available “captions” and writing into said

Registry the name of the caption file selected by the user;

writing into the Registry the actuating value of the Module Core.exe through the Module D Mailer.exe.

displaying to the user the video take being performed and the surface operating as a confirmation button or key;

actuating the directional loudspeaker 23 supplying the user with information;

writing into said Registry the photogram capture command and actuating the cropping method (Module Core.exe);

displaying to the user the selected end product, including said “subject”, i.e. the face of the user cropped at the end of the processing carried out by the Module Core.exe, FIG. 5D);

writing into said Registry the printing value which will be sent to the printer 19 through the Module D Mailer.exe.

displaying to the user the possibilities offered by the system, such as new views, the sending of the newly made card through Internet, etc.

Module B: Core.exe (Written by Visual C++®)

This is the program which, through the video acquisition board 16, captures the images formed by the video-camera 18. This program operates to convert the system input video signal and transform said signal into an ordered pixel sequence. This pixel sequence would constitute the mathematical expression of all the geometric patterns which are present in the considered image.

This software Module B will operate to extrapolate the image of the subject 6 from the “background-subject assembly”, FIG. 5C, to locate said image on the view or panorama 4, FIG. 5A, selected by the user through the Module A TheMask.exe, from the plurality of the system prestored views. This is made by analyzing different chromatic equivalency areas forming the video-camera 18 taken image, i.e. the “background-subject assembly” or “second image” (FIG. 5C), with respect to a virtual “reference background” or “first image” (FIG. 5B1) generated by the BackBuild.exe. This can be performed as shown in a more detailed manner in the following operating disclosure of said Module B.

Module C1: BackIni.exe (Written by Visual C++®)

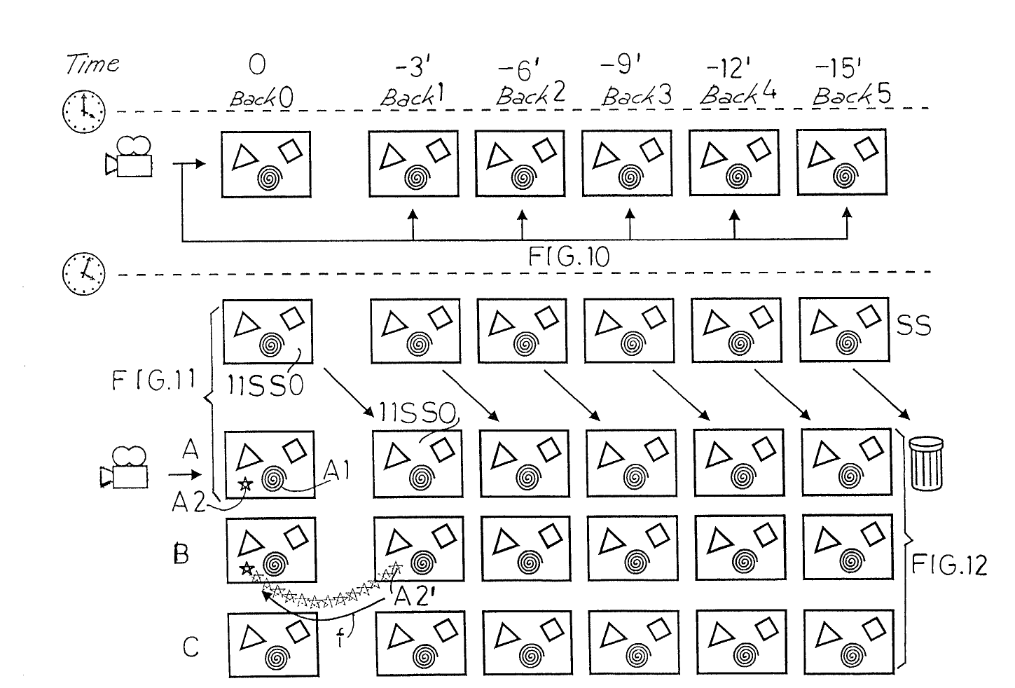

This Module is actuated both as the system is turned on, as the sequence of file images Back0-Back5, FIG. 10, is initially formed, and automatically cyclically for clearing and “cleaning” the files Back0-Back5. In this manner a sequence of files Back0-Back5 free of residues deriving from the processing performed by the Module C2 BackBuild and which, by accumulating, would cause a declining of the cropping quality, is recovered.

More specifically, said module will carry out the following operations or steps:

actuating the acquisition board 16;

writing into the Registry the information for actuating the illuminating or lighting device 22;

talking a photo of the encompassing outer environment or “taken background” (FIG. 5B) which will be written in the files from Back0 to Back5 (FIG. 10); switching the lighting device 22 off.

Module C2: BackBuild.exe (Written by Visual C++®)

It should be pointed out that, to provide a reliable cropping, it would be indispensable to have a good “reference background” or “first image” (FIG. 5B1).

Depending on the command received by the Module E Golem.bin, it will perform, in a detailed manner, the following operations or steps:

shifting the image previously present in the file Back0 backward to the file Back1 and so on for all the files Back to the file Back5, the image of which, flow “old”, would be suppressed, as schematically shown in FIGS. 11 and 15;

actuating the acquisition board 16;

writing into the Registry the information for actuating the lighting device 22;

taking a photo of the encompassing outer environment or “taken background” (FIG. 5B) which will be written in the file Back0 (FIG. 12);

switching the lighting device 22 off.

Carrying out the background interpolating function ( ) FIG. 12, provided for removing image transient noises, such as reflected lights, which would negatively affect the subsequent cropping operation by the Module B Core.exe.

In particular, between the image Back0 and the 5 Back1-Back5 backgrounds, the chromatic similitudes among the pixels at the same locations are reached and, if a pixel is found as corresponding in at least two previous images, then it will be confirmed, otherwise it will replaced by the twin pixel of the Back1 image, i.e. was the latest reference background, FIG. 12.

As schematically shown in FIG. 12, line A, the pixel, such that schematically indicated by a coiled line A1, is held in Back0 since it is present in at least two images or preceding events, whereas the pixels, represented, for example, by a small star A2 present exclusively in Back0 are replaced by the “twin” pixels present in Back1 as is schematically shown by the small star A2′, in thin line and by the arrow f, FIG. 12, line B, after closing the small star A2′ of the “hole” left by the small star A2 in Back0, FIG. 12, line C.

Module D: “Mailer.exe” (Written by Visual Basic®)

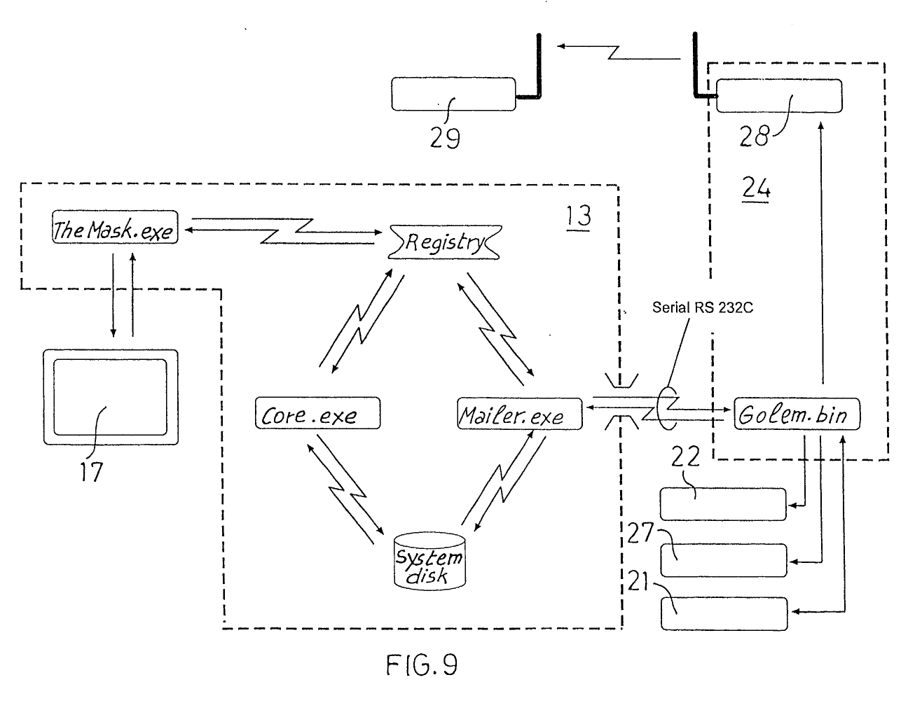

This module operates to route all the messages to the different components of the system and, more specifically, from the user interface, Module A, “The Mask.exe”, and the Module B, “Core.exe”, during the acquisition from the video-camera 18 by the outer PLC 24 for managing or controlling the lighting or illuminating device 22 and the operations of the banknote reader 21, by controlling the directional LED 27 and the directional loudspeaker 23 and, finally, by the printer, since it controls the proper carrying out of the printing processes provided for the individual products, FIG. 9.

All the message exchange between the Module D, “Mailer.exe”, and the Module B, “Core.exe”, is carried out through the Registry of the computer 13, as conceptually shown in FIG. 9. According to the invention, in the system a new key, called Mainstreet, is formed, and in its inside the environmental variables and the commands to be carried out are stored. The message flow is of a bidirectional type, to update each module on the operations performed by the other modules.

In actual practice, the communications between the Module D, “Mailer.exe”, and the Module E, Golem.bin, residing in the outer PLC 24, are carried by using the serial port of the system and, also in this case, they are bidirectional communications.

Module E: (Golem.bin (Assembler®)

This Module E is resident in the outer PLC 24. The communications between the central computer 13 and the outer PLC 24 are performed serially by the routine RS-232C.

The Module E Golem.bin provides, more specifically, the following operations or steps:

controlling of the “timers” and the presence sensor 26 actuating and allowing the “taken background” taking operation;

actuating the Module C2 BackBuild.exe.

To that end, after a present cycle period, for example 180 seconds, if the presence sensor 26 does not detect any movements of persons or objects in the free taking field of the video-camera 18, then this module C2 will automatically a photo of the encompassing outer environment or “taken background” (FIG. 5B) to be taken. These takeouts constitute a self-updating file operating as a base for providing the virtual “reference background” 5B1 according to the invention. The image (FIG. 5B1) will be then used by the Module B, “Core.exe”, for extrapolating from the image, FIG. 5C, the subject areas 6 which are not present in the “reference background”, FIG. 5B1.

turning the lights 22 on at the taking time;

actuating the LED 27;

communicating to the computer 13 the banknotes read-out by the banknote or money reader 21.

By a system arranged in an apparatus 31, with the video-camera 18 arranged in different shops or stores, optimum cropping operation results of the “two image” type have been obtained by using a BackBuild cycle with a period of 180 seconds.

It should be pointed out that, with the exception of the Modules B “Core.exe” and C2 “BackBuild”.exe, all the remaining software components or Modules A, C1, D and E do not contain particular technological novelties, and they can be easily made by one skilled in the art depending on their functions and supplied information, thereby they will be not disclosed in any further details.

With reference to the figures and flow-charts, the coordinated functional operating procedure of the different operating modules A-E, or operating programs of the process for cropping composite cards 3 according to the present invention will be hereinbelow disclosed.

Turning the System on

As the system or apparatus is switched on or started, the following operations will be performed:

actuating the Module E Golem.bin and loading the operating system,

starting the module C1 BackIni.exe, driving the video-camera 18 in order to perform the first taking or overshooting operation;

loading the Module D Mailer.exe;

actuating the Module TheMask.exe, in the user information Idle Loop section.

Operating Cycle of the Apparatus or System, Without Intervention by the User

In a non-use period of the apparatus, the screen 17 will display an image loop, including images for attracting the user attention on the apparatus, and for supplying “a priori” a series of indications related to the use of the system.

Periodically, for example typically each 180 seconds, the Module E Golem.bin will actuate an attention step for the presence sensor 26.

If, for a cycle of 30 seconds, for example, the sensor 26 does not detect the presence of persons near the apparatus, then the Module C2 BackBuild.exe will be actuated.

If, during this 30 sec cycle persons or other objects or animals pass near, susceptible to undesirably and randomly enhance by transient images the “taken background”, FIG. 5B, then the 30 sec timer will be cleared, and the attention cycle to the presence sensor 26 will be reinitialized.

This procedure, and the consequent “reference background” making procedure will be cyclically repeated during the operation of the apparatus.

Operation Cycle of the Apparatus or System, With an Intervention of the User

As a subject touches the screen 17 for using the apparatus, the presentation image loop is stopped and a screen is displayed for choosing the use language. By touching the selecting area on the screen 17, the system will store the variable related to the language to be used, and the proper message set will be loaded.

The following screen display will show the money inlet request, by enabling the banknote or money reader 21 or the like. For each banknote, coin, credit or other used system, the reader 21 will inform the outer PLC 24 about the introduced amount, which will be routed through the serial port to the Module D Mailer.exe to store it in the Registry of the computer. The Module A TheMask.exe will read the value present in the Registry and will display on the screen 17 the introduced amount and possible balance to be introduced again. As a previously set value is reached, the banknote reader 21 is disabled, and on the screen 17 is displayed a screen display holding herein, for example, eight themes (for example eight different types of views or panoramas, such as seascapes, mountain views, town views, soccer team views, basket views and so on), for the view 4 images and a selection for making the mentioned “special product” (which will be disclosed hereinafter).

By touching the area of the screen 17 related to one of the eight present themes, or stored in the system, six “view” or “panorama” images of the preselected theme will be displayed, therefrom the user can perform his/her choosing. By touching the desired image on the screen 17, the name of the file holding the image for use as a definitive background of the card 3 or “view” 4 will be written in the Registry. The following screen display will show a selection for locating the “subject” 6 with respect to the “view” or “panorama” 4, for example at the left, at the center or at the right. The selected information will be stored in the Registry of the computer 13. The following screen display will afford the possibility of adding wordings 32 (FIG. 3) from a series of, for example, eight previously stored wordings. In an affirmative case, the name of the file holding the wordings 32 will be stored in the Registry of the computer 13. The following screen display containing the confirmation key therein, will actuate the Module B Core.exe and generate on the screen 17 a window showing the signal taken by the video-camera 18, or the user face. The actuating of the Module B Core.exe will generate a series of inner messages which, through the Modules Mailer.exe and Golem.bin, will turn the lights 22 on, while actuating the directional LED 27 as well as an optional playing of a voice message from the directional loudspeaker 23. As the virtual confirmation key on the screen 17 is pressed, then the operations for providing a composite card 3 will be started. The first operating step is that of making the reference background.

Making of the “Reference Background”

This operation which, as above stated, is also automatically cyclically performed without intervention by the user, occurs as the user provides a command, for example touches the screen 17, for causing the video-camera 18 to take the user face, by actuating the Module C2 BackBuild.exe. This is the first step of the chain of functions to perform the cropping method according to the invention.

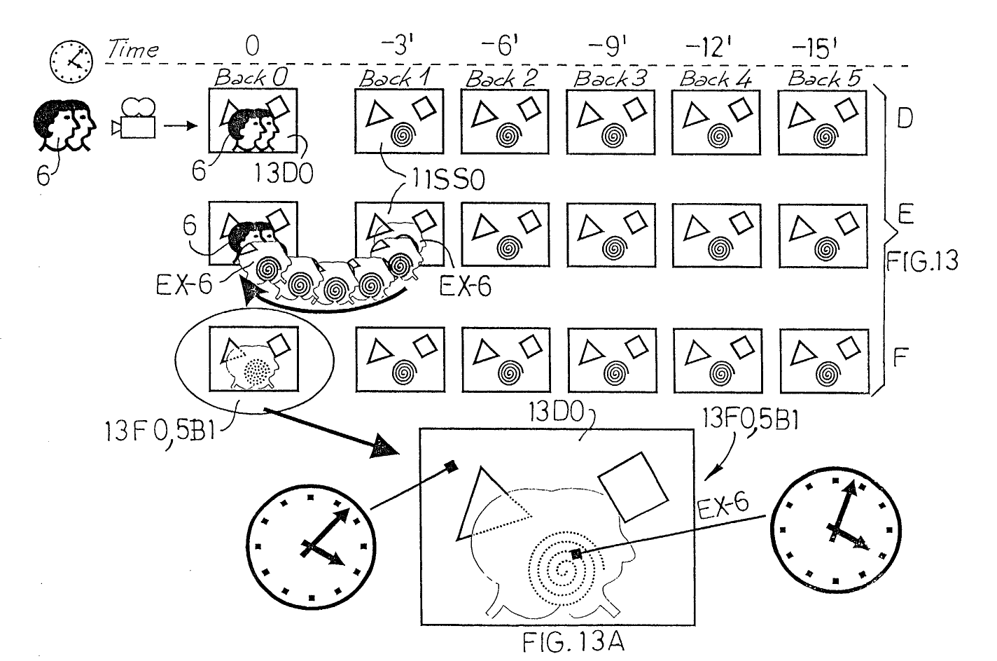

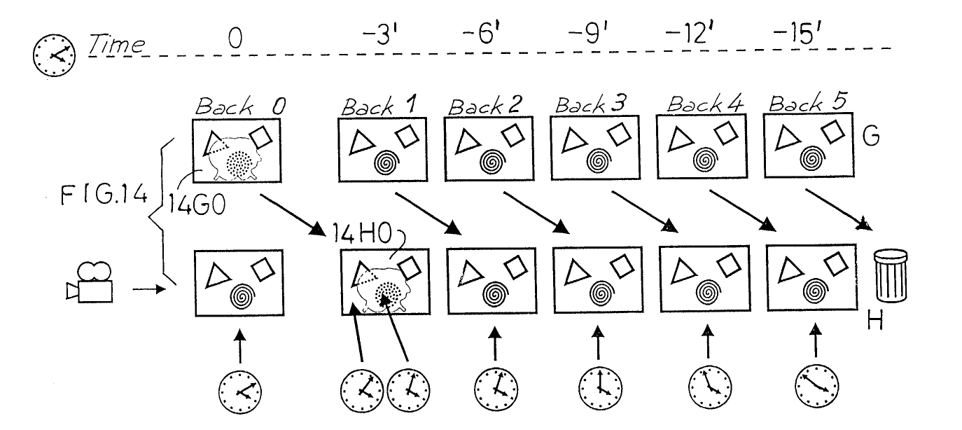

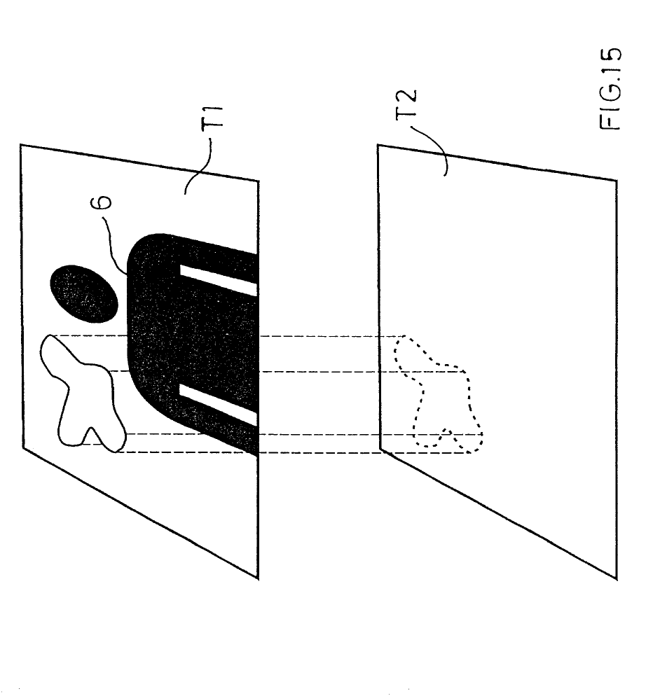

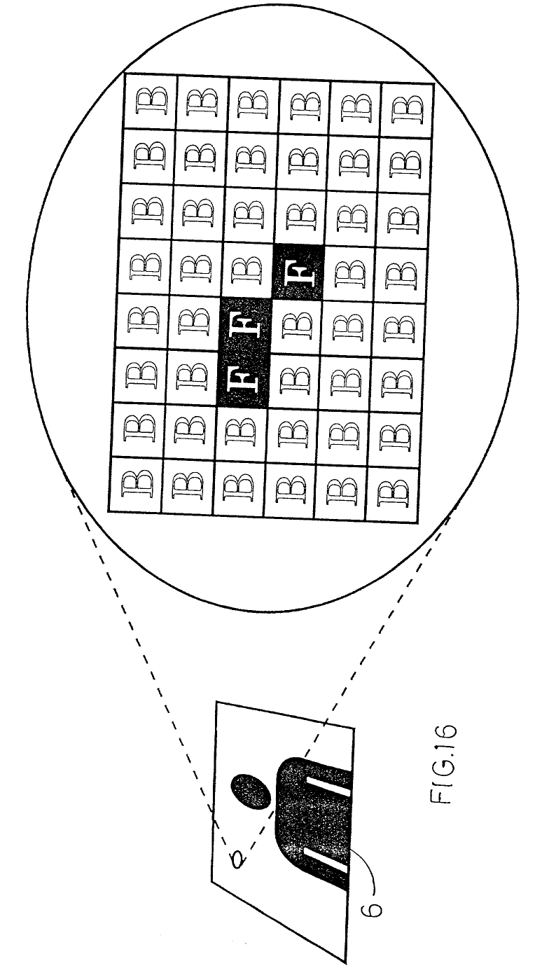

The result of this operation will be a virtual “reference background” or “first image”, (FIG. 5B1), which is “updated” at the taking time both for the background area not covered by the subject 6, and for the portion thereof covered by the subject 6, which is “recovered” by the latest “reference background”, i.e. Back1, FIG. 13.

More specifically, the updating of the “reference background” is performed as follows: suppose that at hour 16.07 the user, in the illustrated case two friends, has/have commanded the taking of their faces, i.e. the taking of the “background-subject assembly” 13D0, FIG. 13, line D. This “background-subject assembly” will obviously coincide with the “taken background”, for example as shown in FIG. 5C. At the same time, in Back1 of FIG. 13, line D, will be present the “taken background” image, 11 SS0, which has been previously taken, i.e. three minutes previously, i.e. at hour 16.04 , FIG. 11, line SS, and successively shifted through the file Back1, FIG. 13, line D.

To provide now the “reference background” 11SS0 of hour 16.04, as updated at the time of the following “taken background” or “reference background” of hour 16.07 (to be used for cropping the subject 6 from the “background subject assembly” 13D0 likewise taken at hour 16.07) in the “reference background” image of hour 16.97, it will be necessary, from a side, to preserve all the areas outside the subject 6 and replace all the areas of the subject 6 by an equivalent area, showing an image present before the arriving of the subject, and which, according to the present invention, will be available in the “taken background” of hour 16.04, i.e. in the image 11SS0, FIG. 13, line E. This is made by applying the interpolating background function ) which, in this case, will consider the subject 6 in Back0 as a noise to be suppressed and replaced by “twin” pixels from the preceding “taken background” 11SS0, as schematically shown in FIG. 13, line E and in FIG. 13A. The result will be virtual “reference background” 5B1, since it has been artificially constructed by “assembling” two areas pertaining to two “reference backgrounds” taken at different times and, more specifically, an area 13D0 taken at hour 16.07 and an area EX-6, indicated by a thin line, and taken at hour 16.04.

After having completed the digital making or building-up of the virtual “reference background” or “first image” (FIG. 5B1), the “subject” 6 or the user face on the second image (FIG. 5C) will be cropped by the “two image” cropping method according to the present invention.

From FIG. 14 it should be apparent that in Back0, line G, a “reference background” 14G0 successively shifted to Back1, line H, is present. This “reference background” has been taken at hour 16.07 and the portion thereof corresponding to the preceding subject will be performed in turn three minutes before, i.e. at hour 16.04.

The use of this image of “reference background” in Back1, line H, for providing a virtual “reference background” in Back0, line H, could generate a transfer to 14H0 of defects present in the image in Back1, line H. In order to prevent said defects from being transferred, according to the present invention it is provided to periodically perform, for example, each 10 revolutions of BackBuild, the background interpolating function with a revolution without any background interpolations and to restart from zero, i.e. from a new “taken background” as transferred to Back0 and copied in Back1 to Back5.

Two Image Cropping

The first operations are performed in preparation to the following functions.

1. Shifting of the Pixels of the “Background-subject Assembly”

The “background-subject assembly” pixels (FIG. 5C) are shifted by the acquisition board 16 buffer to a series of working arrays in the RAM store called ForeR, ForeG, ForeB, ForeN and ForeZ, which will then hold therein the data called Foreground. The arrays ForeR, ForeG and ForeB will respectively hold therein the values of the chromatic components red, green and blue of the individual pixels, the ForeN will hold therein the markings for attributing the pixels of the “background-subject assembly” (FIG. 5C) respectively to the “subject” or to the “background”, where the array ForeZ will be used as a “tank” for transit temporary data related to the single pixels.

The term “array” means herein the precise word for defining a store area (RAM) in which homogeneous data is catalogued. The term “buffer” is deliberately not used herein since, in the considered case, this could seem as ambiguous, since the video-camera buffer is a physically existent element, whereas said arrays are generated by allocating a portion of the RAM of the computer 13.

2. Shifting Pixels of the “Reference Background” (FIG. 5B1)

Likewise to the preceding function, the pixels of the “reference background” are shifted to a series of working arrays called BackR, BackG and BackB, which will then hold therein the data of the image Back0, called “Background”.

3. First Differential Analysis (Quantizing Fore ( ) function)

The first differential analysis based on the pixel isoareas among the arrays Fore and arrays Back is now performed.

This is a cyclic function which is automatically repeated to analyze the full image pixels and it would not be possible to know “a priori” the iteration number to be performed. The function of this analysis provides to collect the Foreground data in homogeneous areas, or isoareas, in which the pixels would have a chromatic similitude. This area will be defined by analyzing the chromatic similitudes of adjoining pixels.

It is found that the effect of this analysis type is analogous to that of an expanding “oil spot”, the limits whereof are represented by a chromatic offset exceeding the tolerance parameters. Having defined a pixel set with homogeneous features, which pixel set will form accordingly an isoarea, all the pixels forming this isoarea are assigned with a working color stored in the working array called “PointerFore”, which corresponds to the net average of the chromatic values of said isoarea. FIG. 15 shows that the configuration and location of the thus defined isoarea Fore T1 is “projected” on the image present in the Back T2 arrays. The average color obtained by the projection of the shape of the isoarea Fore on the Back array is stored in the working array called “PointerBack”. As a result of this first differential analysis based on a quantization of the image colors, to new working arrays called PointerFore and PointerBack, respectively holding therein a pair of the background-subject assembly” image, FIG. 5C, or “second image” and a copy of the “reference background” image, FIG. 5B1, or “first image”, constituted by the set of the isoareas identical as shape and location, but “smoothed” with the average of the colors of the respective sources, are obtained.

4. Second Differential Analysis (Quantizing ( ) Function)

A second differential analysis based on the chromatic isoareas among the arrays holding the image Fore and the arrays holding the image Back is then carried out. This function is operatively very similar to the preceding function, i.e. the “oil spot” search function, with the difference that the isoareas are now defined independently both for the Fore arrays and for the Back arrays. The compared features are the pattern or shape and location of the isoarea, in an independent manner for the two arrays. Upon ending the definition of the areas, the size evaluation is started. If the size difference of the two isoareas Fore and Back is found to be less than 10%, then these isoareas will be evaluated as similar since, being said isoareas present in both the images, i.e. in the “Background” image and in the “Foreground” image, said areas will pertain to the respective “background” or bottom, and not to the “subject” of the “background-subject assembly” image, FIG. 5C. If a similitude is found, both the isoareas will be forcibly recolored by a pure white color in both the PointerFore and PointerBack arrays. The result of this function will have no immediate effect on the evaluation of the pixel as “background” or as “subject”, but it will represent a further improvement of the result obtained from the first differential analysis, thereby suppressing those areas which would have not been considered by the chromatic similitude analysis.

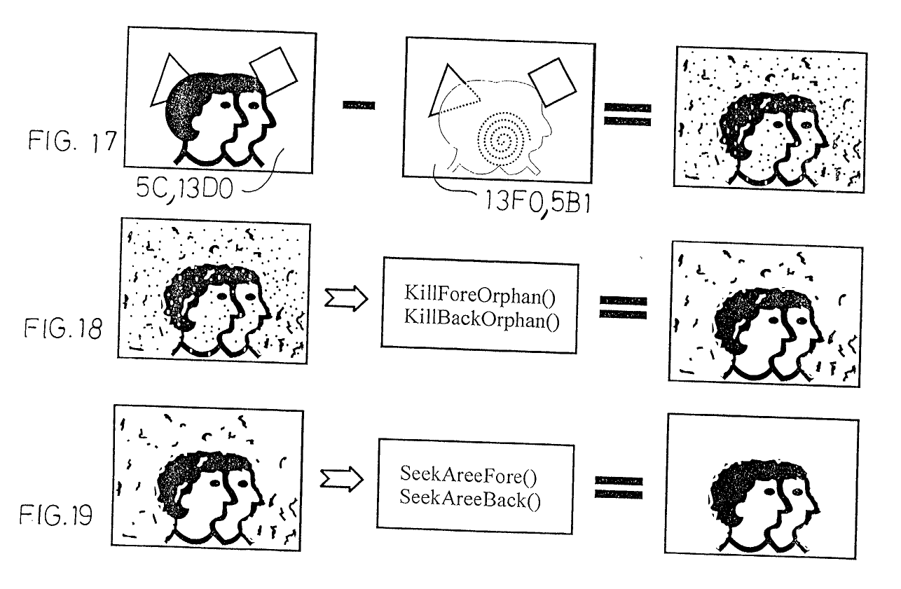

5. Boolean Comparing (Quantibool ( ) Function) FIG. 17)

A boolean comparing of the pixels present in the PointerFore and PointerBack arrays is now performed. For each pixel the colorimetric values are read and, if the chromatic differences fall within a set tolerance range, then the pixel is marked in the ForeN array as “background” (i.e. as a suppressible pixel), otherwise said pixel will be marked as a “subject” pixel (i.e. as a preservable pixel). Then, the information for each individual pixel relating to the pertaining of one of the two sets “background” or “subject” of the “background-subject assembly”, FIG. 5C, will be stored in the ForeN array.

FIG. 17 schematically illustrates the operating mode of the boolean comparing between the “background-subject assembly” 13D0 (or FIG. 5C) and the “reference background” 13F0 (or FIG. 5B1).

6. Third Differential Analysis (Colorimetric Analysis ( ) Function)

A third differential analysis, based on the individual pixels between the Fore arrays and Back arrays is then performed. The image pixels present in the Fore array are individually compared against the twin pixels present in the Back array. This comparing is based on a chromatic similitude of the single pixel pair, and on an offset of the color delta with respect to the adjoining pixels, for example that arranged immediately at the left of the pixels being analyzed. If this difference remains within a given tolerance range, to be defined during the installing operation, then the two pixels will be evaluated as suppressible, since they will both pertain to the “background” of the “background-subject assembly”, FIG. 5C, and, accordingly, they will be signed or marked as a “background or bottom” inside the array ForeN.

Otherwise, no changing of the ForeN array marking will be performed. As it should be apparent, this third differential analysis represents a further refining of the results obtained from the first and second differential analyses.

After the last differential analysis, an image will be obtained which will aproximatively represent the cropped subject, however with a presence of a comparatively large amount of loose, isolated pixels, erroneous areas and cutting unnatural corners which cannot be interpreted by the preceding analyzing and comparing method, or like methods, with a consequent need of further cleaning/integrate the image.

6A. Multiple Function and Processing

Then, the image will be further processed by statistic parameters in multiple stages. The first two functions will operate to suppress the “orphan” pixels, i.e. the isolated pixels, FIG. 16, by an example with three-pixel orphan.

7. KillForeOrphan ( ) Function), FIG. 18

As deriving from the definition itself, the above mentioned Fore array is analyzed, and the isolated pixels therein are searched, in this case those pixels marked as pertaining to the “subject” and encompassed by those pixels marked as pertaining to the “background”, or by another pixel marked as “subject” at maximum. All the pixels having these features are marked as pixels pertaining to the “background” and accordingly supprimible.

8. KillBackOrphan ( ) Function), FIG. 18

This function is equal to the preceding function, with the difference that it will search “background” pixels encompassed by “subject” pixels. As it is performed, the function will close the “hole” in the “subject” by modifying the marking from “background” to “subject”. The operating manner of the suppressing functions disclosed at item 7 and 8 is shown in FIG. 18.

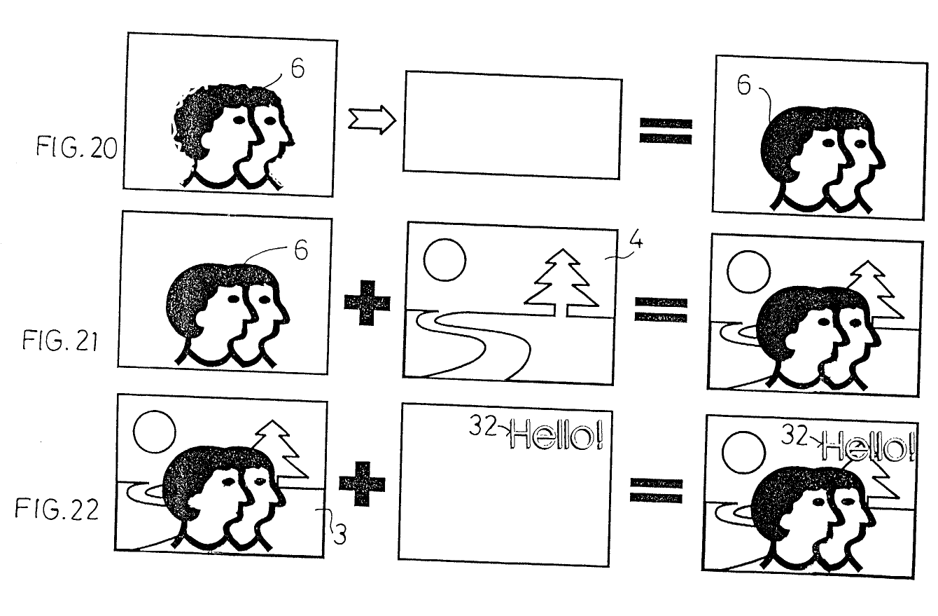

9. SeekAreeBack ( ) Function) FIG. 19

At the end of the functions disclosed at items 7 and 8, those small defects providing a “snow” type and which are usually present in great amounts in the images will be removed from the image. However, some erroneous area, comprising a number of pixels greater than a single “staple” of the snow effect can still remain (FIG. 16). This function will search in the “subject” areas sets of adjoining pixels with a “background” marking, and will verify the size of these pixels. If the pixel size is less than a set threshold, typically 2000 adjoining pixels, then this area will be marked or signed as a “subject”.

The searching procedure for establishing the area size will be the same as that of item 3, in which all the image pixels are analyzed by the “oil spot” method, while checking the adjoining continuity of the “background” pixels and of the “subject” pixels.

10. SeekAreeFore ( ) Function), FIG. 19

This function is a reverse function from that of item 9, since it will search “subject” areas encompassed by “background” areas.

The operating manner of the functions of items 9 and 10 is shown in FIG. 19.

11. Filing or Trimming ( ) Function), FIG. 20

At the end of the area cleaning and integrating operations, the image pixels will be free of any errors, related to their evaluations between “background” and “subject”, but the edges of the cropped “subjects” may still have cutting and unnatural corners.

This function, which is herein called “filing” or trimming function is specifically designed for smoothing the limit regions between “subject” and “background”, by making the edge continuity even.

If excessively sharp bends are encountered along the edge, then this will mean that the respective considered pixel is an anaesthetic “spike” with respect the edge evenness. This pixel, accordingly, is suppressed. This is a recursive function, operating for a preset number of times. Good results have been obtained, for example, by three repetitions.

The operating mode of this function is schematically shown in FIG. 20.

12. Soft ( ) Function

The “subject” is now well defined, its edges are even, but an insertion thereof in the “view” or panorama 2 would involve aesthetic problems making it unnatural. In fact, the edges are excessively sharp and defined, and are devoid of the characteristic light reflections which are typical of a “subject” present in a given environment. In order to suppress the above mentioned drawbacks, good results have been obtained by using an approach which is broadly diffused in the graphics field. In particular the soft O function will search, for all the individual pixels of the “subject”, such as the face of the user 6, the actual distance from the edge of said subject. If said distance varies form 0 to 8 pixels from the edge, then a value defining its clearness with an intensity reversely proportional to the distance from the edge will be applied.

These values are not used as such, but they will be interpreted upon merging the two images, i.e. the “subject” 6 and “view” 4, as preset, and as shown at the following item 14.

13. Definition of the Special Products

If, instead of the composite card 13, the user would select another available option related to a special product, then the “special product” function chain as hereinbelow disclosed, will be followed.

14. Selected “Subject” and “View” Merging Function, FIG. 21

At the end of the analysis/comparing and end processing steps, the remaining pixels of the Fore image or of the “subject” will be embedded in the “view” image as selected by the user.

It should be apparent that, differently from prior methods providing a “layering” of the image, in the inventive method, the involved “subject” pixels are physically replaced in the “view” image, FIG. 21. Thus, a standard Bit map of Windows® will be obtained.

14A. “Subject” Boundary Special Processing Function

In order to make the “subject” edge more natural, a “transparency” or clearness function with a clearness intensity reversely proportional to the distance from the edge is applied. As above stated, the “subject” pixels affected by this function are those pixels included in a distance from 0 to 8 pixels from the edge, to which, for each of the chromatic components of the “subject” pixel, the following formula will be applied:

Cₜ={Cₛ*K+Cₚ(1−K)}

where Cₜ is the value of the chromatic red, green or blue component, t is the value obtained by the applied clearness correction, s is the “subject” pixel, p is the “view” pixel, and K is a constant given by the formula

K=(Dᵣ+1)/Dₜ

where D is the unit distance expressed in pixels, r is the distance of the pixel affected by the edge, t is the overall distance affected by the clearness.

15. Overlay Wording Add Function, FIG. 22

As all the image of the “subject” 6, or of the user face, has been embedded and merged in the image of the “view” 4, then it is possible to add in the latter a graphics image 32, called Overlay, which, a above stated, holds therein wordings selected by the user among a given range of stored wordings or captions, see FIG. 22. The merging process of the two images is the same shown in FIG. 14, where, for locating the “wording regions” with respect to the not affected “background” regions, is used the prior “chroma-key” method, by using, for example, as a discriminating color, a pure green color.

16. Program Ending

The composite image is now complete and the program file, now including herein also other information accumulated during the several operations, is preserved on a disc called “end.bmp”. Then, all the used working arrays are destroyed, and the store assigned for managing or controlling the program objects is recover red to the system. The last operation which is performed before the program end is that of writing the value 1 in the system Registry, at the item “Mainstreet/print”. This is the signal for the Module D “Postino.exe”, indicating that the file is ready and can be printed.

Making of the Special Products

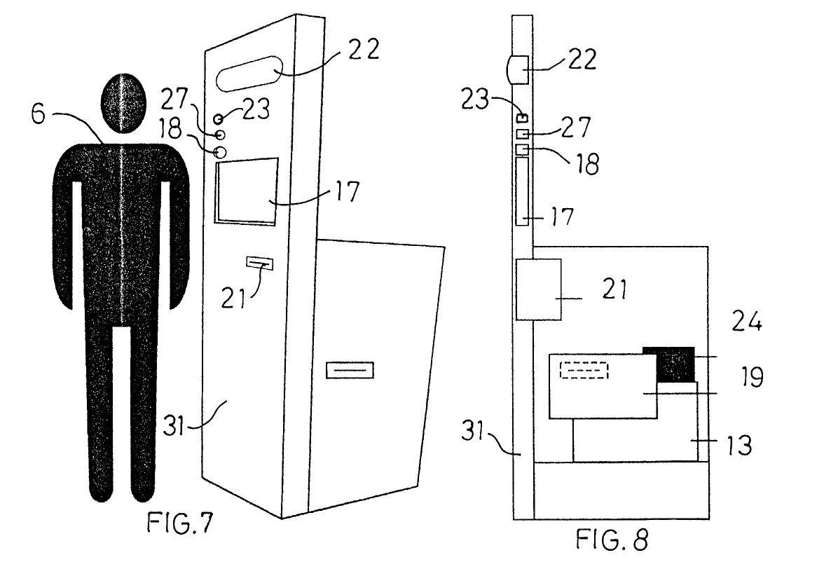

By using the above disclosed automatic two-image cropping method, the data processing end handling method and related integrated apparatus according to the invention, FIGS. 2, 7 and 8, will allow to likewise make a lot of different “special products”, for example in the form of “greeting cards”, “photo-cards”, of several size (FIGS. 23, 24), “stickers” (FIG. 25), “visiting cards” (FIG. 26) and so on. Basically, the difference of the different products will consist of a different “view” 4 applied behind the “subject” 6 or the user face, and the support or medium for the printing operation.

The different declinations of the photo processed by the Module B, “Core.exe”, are performed by a post-processing module 33, which has been specifically written and controls standard data according to procedures which are not per se interesting. An interesting aspect, on the contrary, is the use of the product according to several declinations. In particular, this program or operating post-processing module 33 is embedded in the Module D, “Mailer.exe”, and it can be easily made by one skilled in the art in the light of the disclosed teachings.

With respect to the individual “special products”, the following is specified:

17. Greeting Cards

The greeting cards are substantially made in the same manner of the composite cards 3 with the difference that, instead of a panoramic view as that of a picture card, as “view” 4 is embedded a “view” suitable for a greeting card, as pre-stored and selected by the user among a plurality of other preset “views” likewise to the programs for composite cards. It is likewise possible to embedded a “caption” 32, called Overlay, by using the same method as that shown at item 15.

In actual practice, as the Module B, “Core.exe” ends its operating cycle, as shown at item 13, the screen 17 will display the image of the “subject” 6, i.e. the face of the user embedded in the preselected “view” 4, as well as the wordings 32 preset by the user from the prestored wordings.

A Visual Basic® form, holding a picture box embedding therein the image as suitably reseized for the printing is herein used.

18. Photocards and Stickers

The Module B, “Core.exe”, will preserve an image with the “subject” 6 arranged on a “view” or panorama 4 such as a white background or bottom, or a background of any other suitable color. The post-processing module 33 will provide a form including arranged therein the images constituting the printing format. By way of a merely indicative example, for the stickers (FIG. 25) 16 small images will be provided, whereas for the photo-cards 4 or 6 larger images will be provided (FIGS. 23 and 24). Upon forming the composite image, it will be sent to the printer for printing it.

19. Visiting Cards

A visiting card (FIG. 26) is made likewise the greeting cards.

More specifically, a form reflecting the selected patterns or layout, selected between the prestored layout range is formed. The layout will comprise an image, i.e. the photo processed by the Module B. “Core.exe”, as well as a series of text cells representing the “vessels” provided for receiving the text will be keyed by the user, for example on the virtual key pad displayed on the screen 17, in a not herein shown manner.

By touching one of the text fields, the digital characters of the key pad will fill in the field. In order to edit a further field, it will be sufficient to touch it, and the virtual key pad input will be addressed to this other field.

By pressing the corresponding confirmation field on said virtual key pad on said monitor 17, the layout will be duplicated for a series of copies, for example three copies, on another form holding the actual printing size. Then, such form will be sent to the printer.

20. Sending the Product Through Internet

It is advantageously moreover provided that, indipendently from the product output, i.e. a composite card or a “special product”, it will be possible to send to a receiving party through the Internet.

To that end, the end Bit map is reduced to a size suitable for displaying it on the screen and converting it into the JPG format.

A form will permit the sending party, receiving party as an accompanying possible short message to be inputted, and then the assembly will be integrated into a HTML codified page, and transmitted through the network by modem and phone, by simply introducing the amount required for this service.

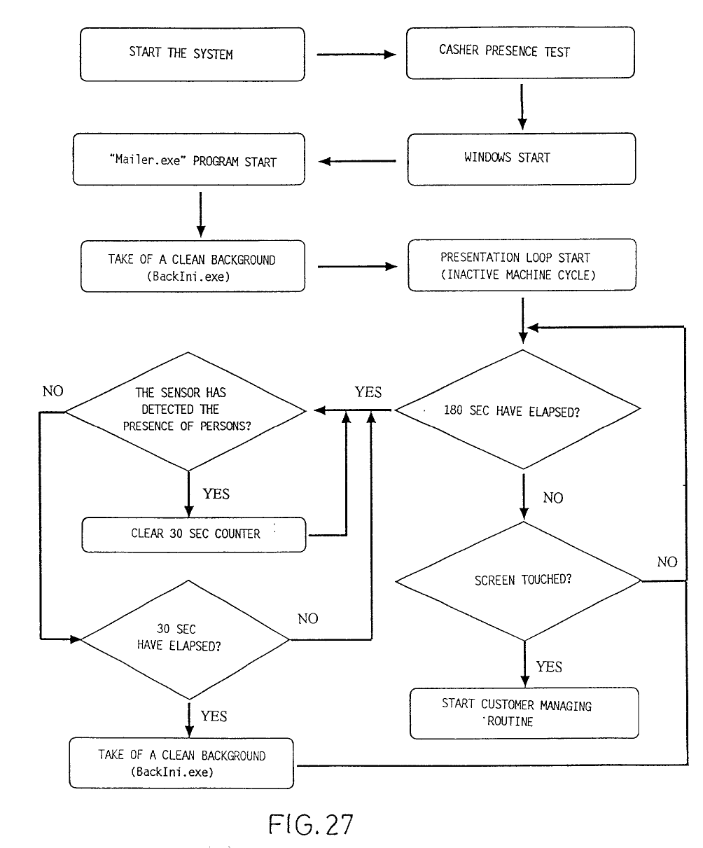

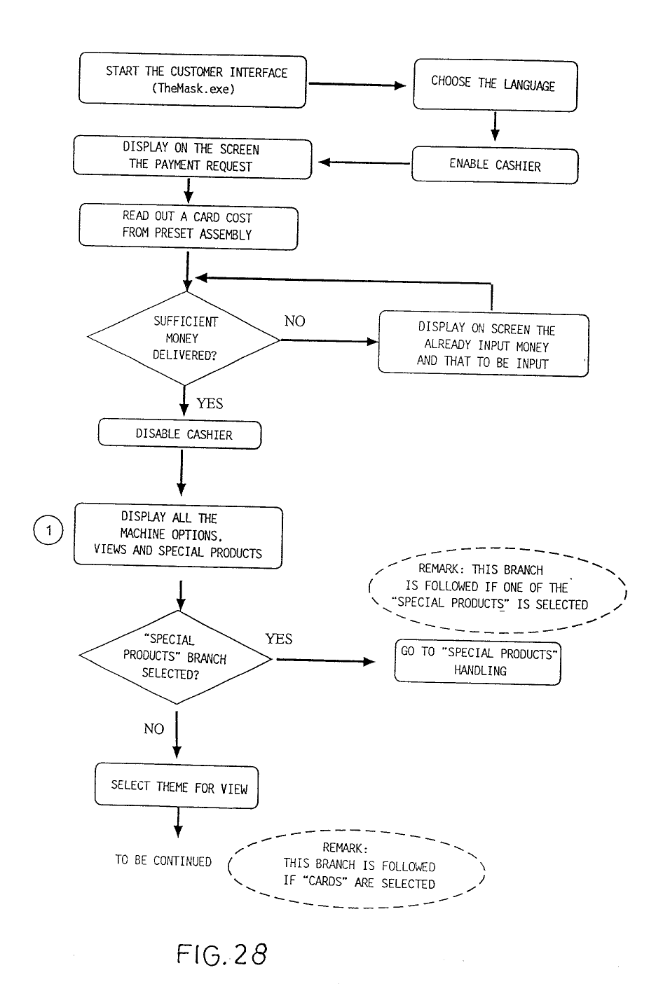

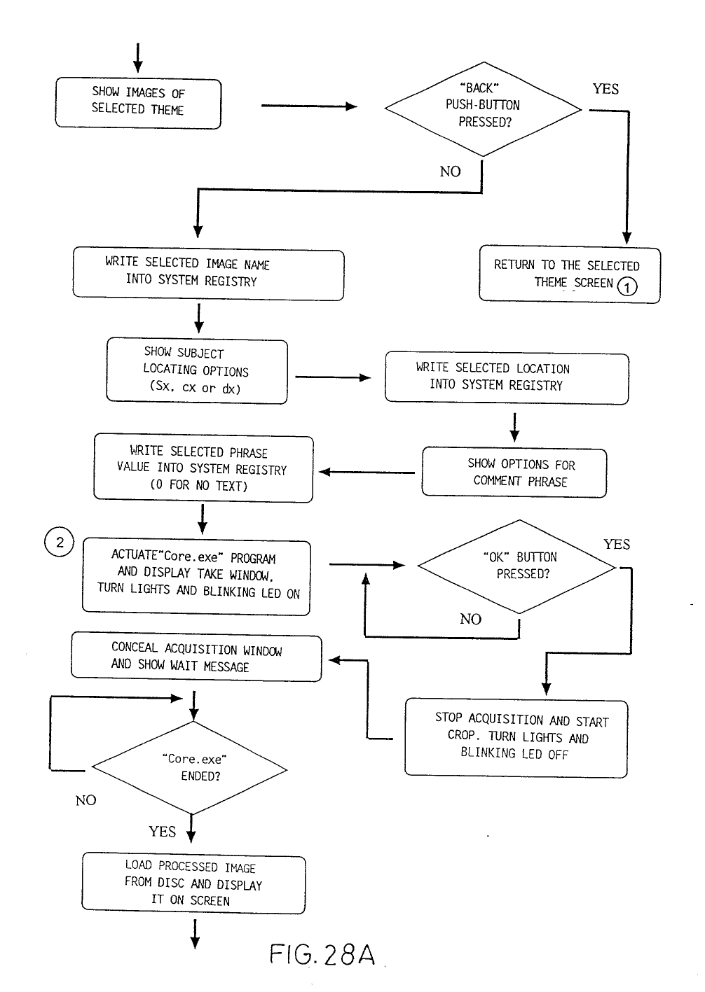

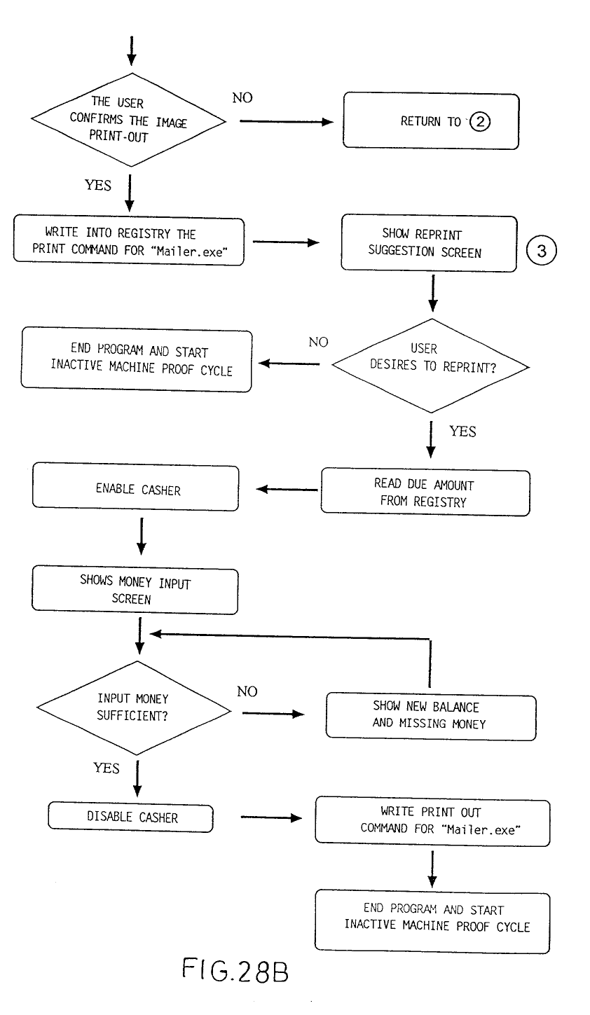

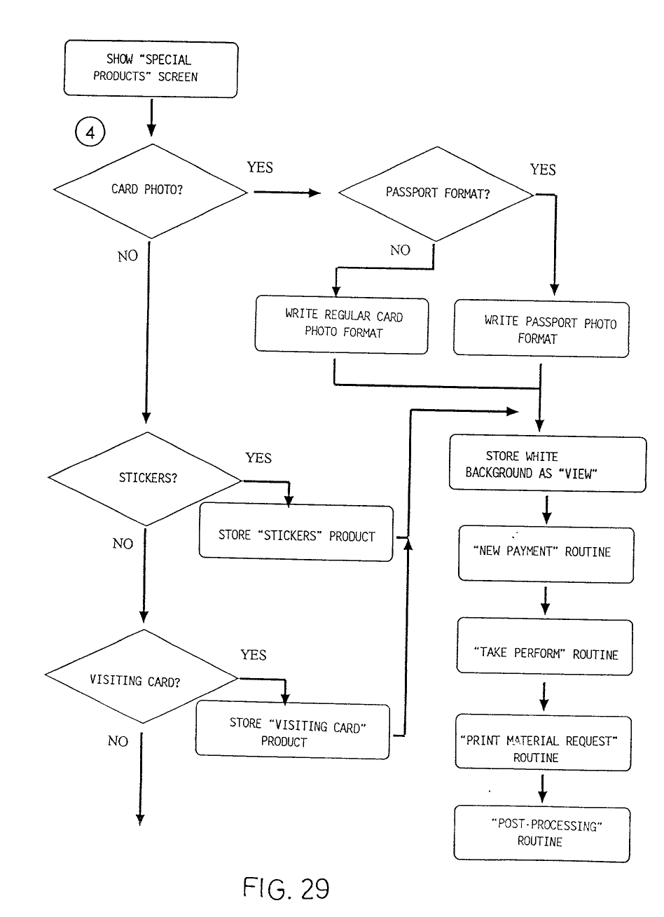

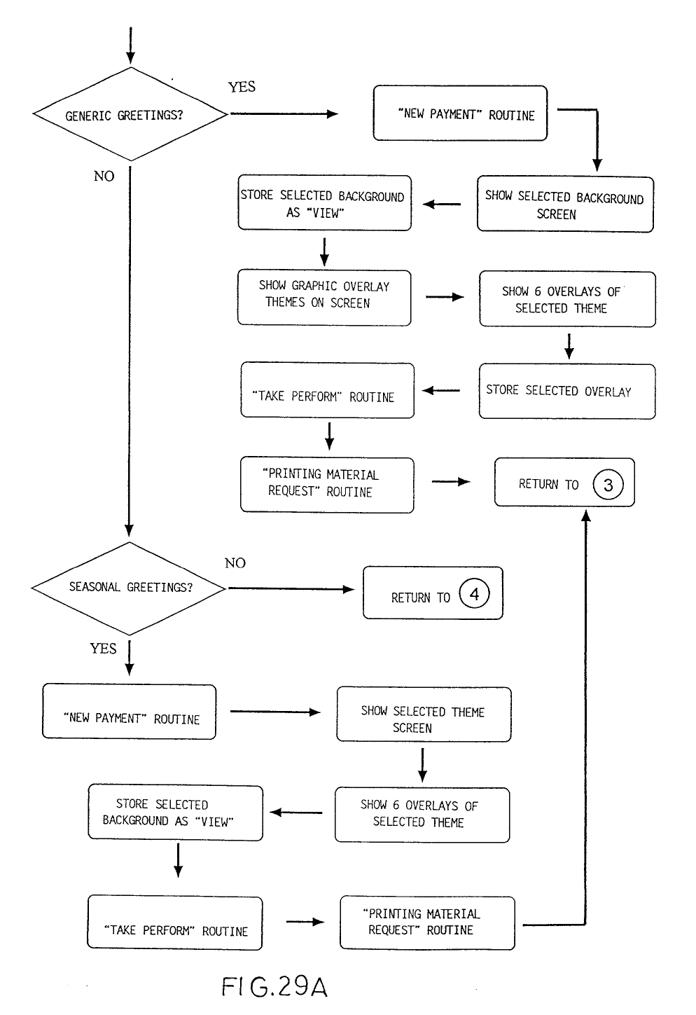

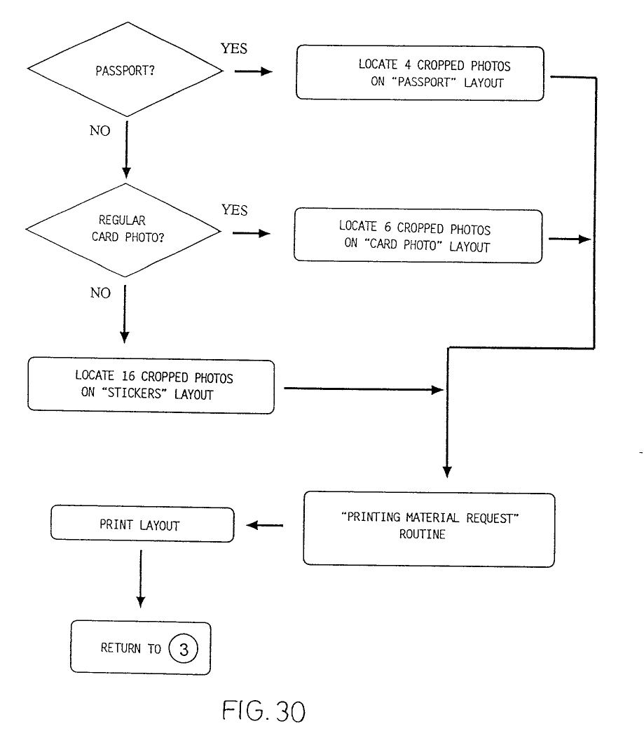

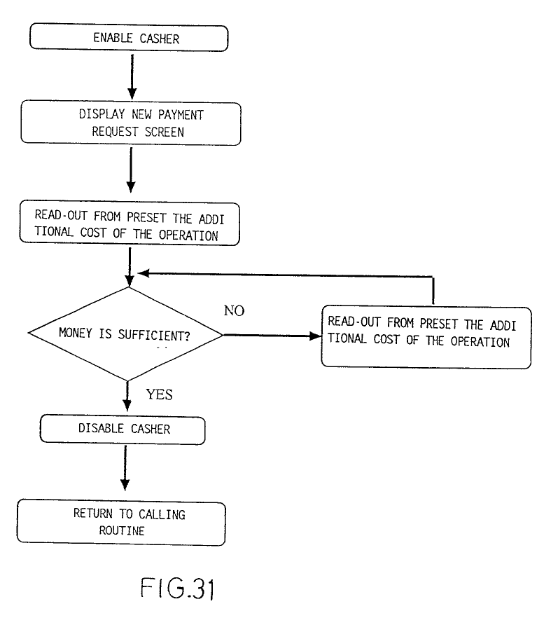

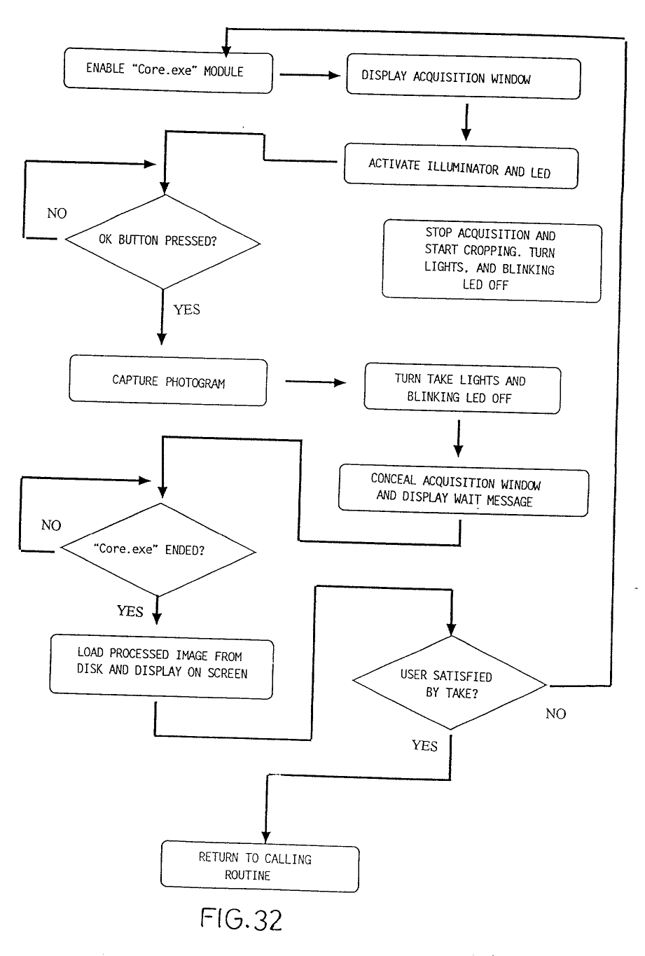

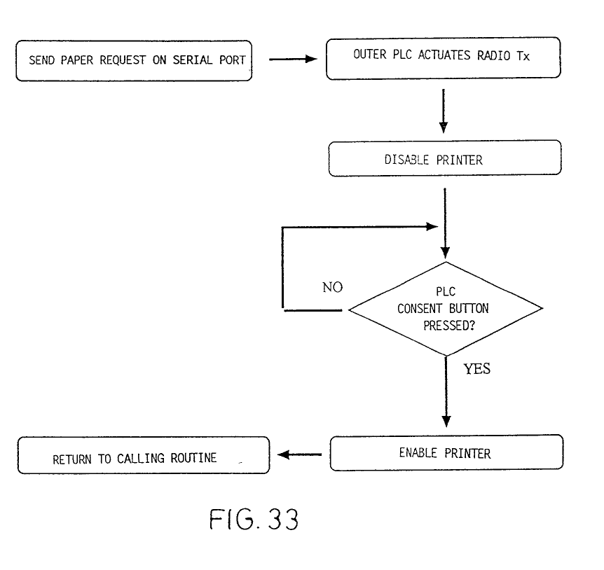

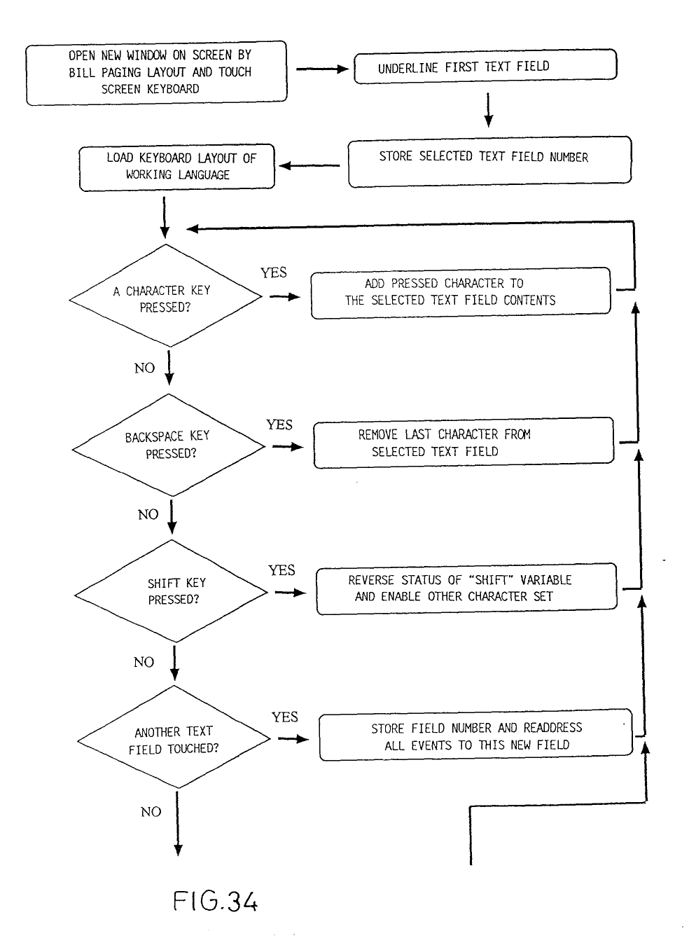

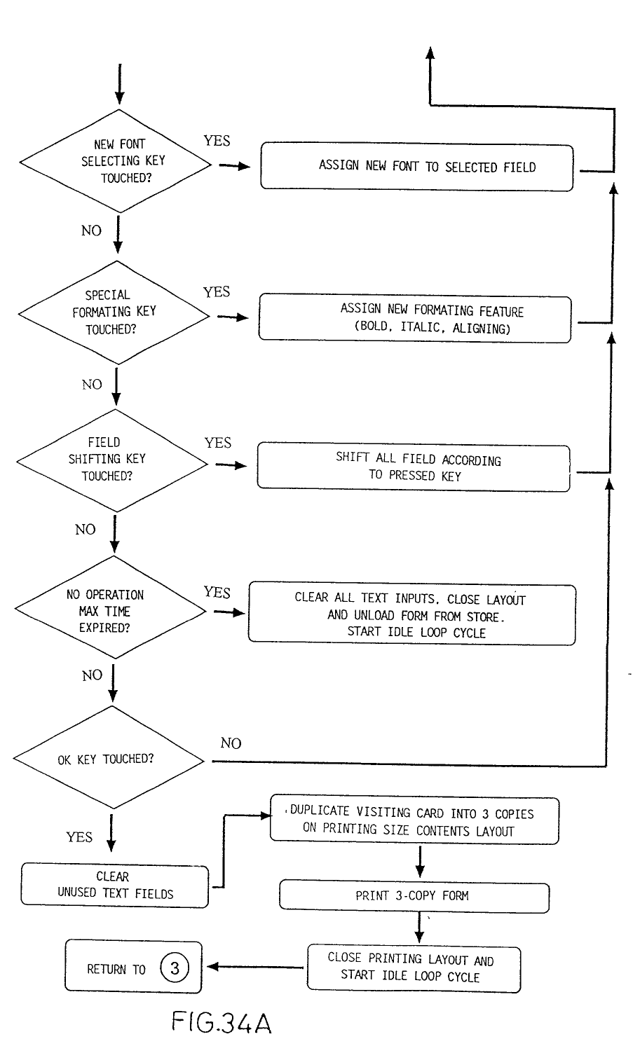

The individual operating steps performed for carrying out the individual software programs or Modules A, B, C, D and E for practicing the teachings of the present invention have been clearly indicated, in a conventional manner, on the accompanying flow charts, shown in FIGS. 27 to 34. In these flow charts, the respective software module or program performing the same has been also indicated at the most significative steps.

Accordingly, said flow charts will be not discussed again herein. It should be apparent that the times indicated in said flow charts are merely exemplary, as discussed thereinabove.

With respect to the above illustrated system the inventor has also found that, by arranging the system in crowded places, upon a continuous movement of persons inside and outside of the video camera surveillance field, the presence sensor, operating based on the microwave technology, sensed the continuous displacements of the persons, even if they were outside of the video camera shooting field, thereby preventing a “clean” reference background from being taken.

Moreover, other types of noises, typically the light reflections or person shadows, were not detected since devoid of mass.

Actually, the difference of the microwave technology used in the presence sensor, and which is based on the presence of a mass, such as the physical body of a person, and the “visual perception” of the system, based on the detection of the images by the video camera, as for the human vision, cold affect the reliability of the two-image cropping system in the mentioned system installation condition, i.e. in crowded spaces continuously traversed by persons passing through the video camera shooting field and/or the adjoining regions.

With respect to the proposed above illustrated method and program or software modules for managing the system, it has been found that the background slipping mode in the background-interpolation function could be in turn improved due to following reasons. In fact, as it should be clear from FIG. 11, the backgrounds from Back0 to Back5, useful for building the reference background are caused to “slip” to provide a “time history” of the shooting conditions. In this connection, it should be pointed out that, at the shooting time, in the Back0 background a “virtual reference background” is built-in, as shown in FIG. 5B1, with elements taken both from the “background with subject” image, FIG. 5C, and from the “reference background” image, FIG. 5B, i.e. without the subject. This, “virtual reference background”, FIG. 5B1, accordingly, will be held in the reference background sequence, and will slip therewith.

At the time in which, in the proposed two image cropping method a BackIni is carried out, see FIG. 10, the Back0 to Back5 reference backgrounds are “updated” by new and more actual images, and, accordingly, the “virtual” background/backgrounds, FIG. 5B1, as well as the old background/backgrounds is/are eliminated from the image chain required for building novel virtual reference backgrounds.

However, if the system is installed in a place where a continuous displacements of persons would hinder a regular BackBuild-BackIni cycle, then the sequence of the Back0˜Back5 reference backgrounds could hold herein only old “virtual reference backgrounds”, i.e. without any prima facie or current information related to the real environment or outside word. For each operation performed by the user, a new “virtual reference background”, FIG. 5B1, would be generated with the danger that it could be consequently “built-in” on “old” already used virtual backgrounds instead of “updated” taken backgrounds, and this because of the above shown and hereinafter disclosed operation of the presence sensor.

Operations to be Performed by the Outside Presence Sensor

The outside presence sensor, which constitutes per se a physical component, or a hardware component of the system, must substantially meet two requirements, and more specifically: 1) it must respect and functionally occupy, as far as possible, the video camera overshooting field, and 2) it must discriminate the same situations seen by the video camera.

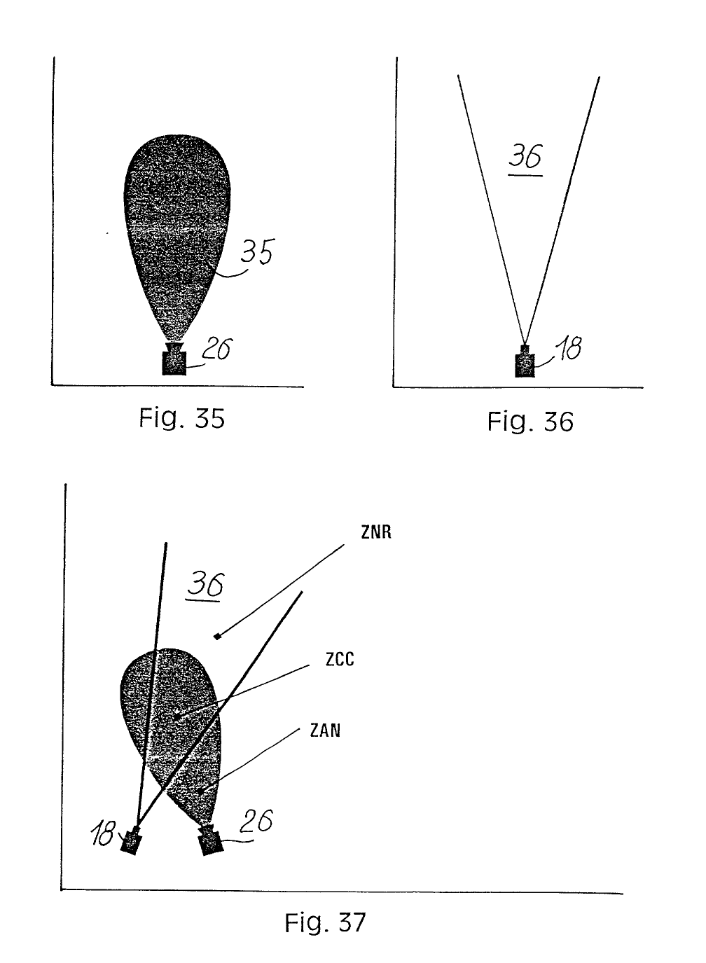

In the embodiment of the system disclosed above in addition to the detection of different objects or articles, i.e. objects or articles either having or not a mass, a parallax problem related to the video camera optical overshooting field occurred, with a consequent impossibility of “focalizing” the sensitivity lobe of the microwave sensor with respect to the taking field of the video camera. This parallax problem, due to a mixed use of the two technologies of the system and method disclosed in the previous application, is shown in FIGS. 35, 36 and 37 respectively illustrating a typical sensitivity lobe 35 of an outside presence microwave sensor 26, in FIG. 35, the taking or overshooting field 36 of the video-camera 18 of the system in FIG. 36, as well as the parallax effects deriving from the use of the mixed detecting technique of FIG. 37, in which ZCC shows a correct coverage zone, ZAN an unjustified alarm zone and ZNR a variation not-detecting zone.

Finally, with respect to the digitally printed products, such as composite cards, they were previously printed exclusively by a single so-called “live” mode, i.e. with the image occupying the overall surface of the card.

The use, as a sensor, of the video camera of the system itself, allows to simplify the control of the overall system by a program or software module, called “BackGenerator.exe”, which is able, through the system or video camera overshooting field, to accurately discriminate the most important features related to the two-image cropping algorithm disclosed in the previous application, which algorithm has been held unchanged.

According to an advantageous aspect of the present invention the suggested BackGenerator.exe program module can fully replace the two above illustrated BackIni.exe and BackBuild.exe modules (Modules C1 and C2), since the functions carried out by these two programs have been embedded in the said BackGenerator.exe software module as illustrated in the hereinafter. Reference will now be made to the BackGenerator.exe program or software module according to the present invention, allowing to eliminate the prior outside presence sensor 26 and to provide a new optical software assisted presence detection.

Operation of the BackGenerator.exe Program Module

The BackGenerator.exe program operates as follows:

For verifying that no disturbing persons or elements are arranged before the apparatus or system, two overshootings or images are remotely taken, for example, at 1 second from one another, by using the same video camera 18 of the system.

The two images are chromatically compared with respect to their pixels, i.e. each individual pixel of the first overshooting or image is measured and compared with the pixel at the same position of the second overshooting or image. If the chromatic difference would be less than a preset given tolerance, then said pixel would be judged as the same, otherwise said pixel being marked as different.

If, within the second image, the different pixels are less than a given tolerance (for example 200, with reference to a total pixel number of over 442,000 of the whole image), then it will be judged that no variations of the two images have occurred and that, accordingly, before the video camera no person is arranged (who could not remain absolutely static), and that any disturbing elements, such as casted shadows (i.e. persons who are directly arranged in the visual field of the video camera optics system but provide light interferences), or light reflections either of a direct or of a mirror or polished element reflected type are present.

If the condition is favorable, i.e. no disturbing element is arranged before the video camera, the system will switch the illuminating system on and will take two other overshootings, spaced by 1 second from one another. These two images too are analyzed by the same technique to verify that, in the meanwhile, no disturbing element has entered the visual field of the video camera lens.

In affirmative positive case, i.e. in the absence of disturbing elements, the system will switch the illuminating system off and store the second overshooting in the Back0 to Back5 files, FIG. 10, i.e. the sequence of the reference files used for building the “virtual reference background” as shown in FIG. 5B1.

It should be apparent that by the illustrated first embodiment of the system during the updating of the Back0-Back5 backgrounds, it was necessary to carry out a background-interpolating operation, to eliminate possible defects of the overshooting or taken image. Now, on the contrary, this is no longer necessary, and represents an important advantage since it is the system itself that “filters” the defects before taking the overshooting.

If the two last overshootings have been found as different, then the system will continue to take overshootings or images, at a distance of 1 second from one another, while performing a comparing thereof so as to found a pair of overshootings or images, without a difference greater than the provided tolerance (for example 200).

If, after a number of attempts, no “reference background” is found, then the system will provide a signal, such as an acoustic signal or warning signal, and open a window on the monitor including a short message asking the persons near the video-camera to move away, while informing said persons that their moving away would be necessary to perform a periodic self maintenance operation, or allow the system to properly operate.

As a like overshooting or image pair is detected, then the lights are switches off, and the video-screen will display a greetings message, thereby allowing the system to complete the last overshooting storing operations.

Optimization of the Back0˜Back5 (Background Interpolation ( )) sequence

As mentioned hereinabove, there are conditions under which the background interpolation mechanism, for building a “virtual reference background”, FIG. 5B1, could be unreliable. In order to overcome such a situation, according to the invention, the logics for managing the Back0 to Back5 reference backgrounds has been slightly modified, as it will become more apparent hereinafter.

According to the first above illustrated method, each time a background interpolation operations was performed, the overall “time history” was caused to backward slip, by eliminating the last reference background (Back5.bmp), with the risk of loosing all the directly taken information, and only the “already used” reference backgrounds were processed, FIG. 12.

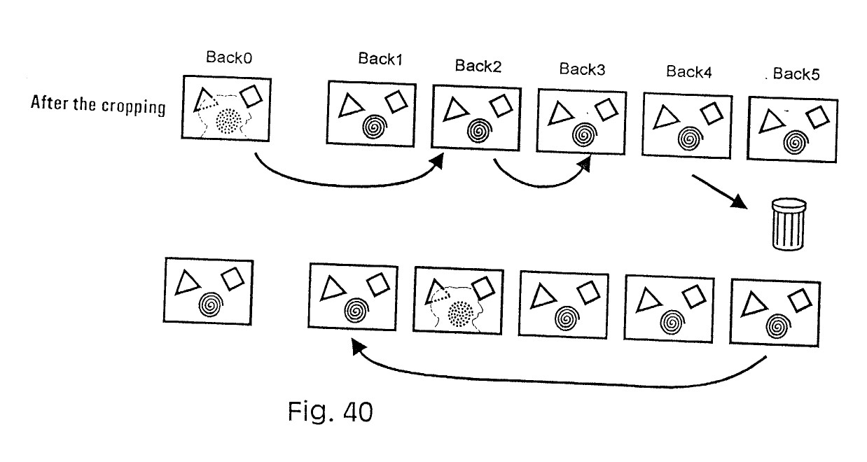

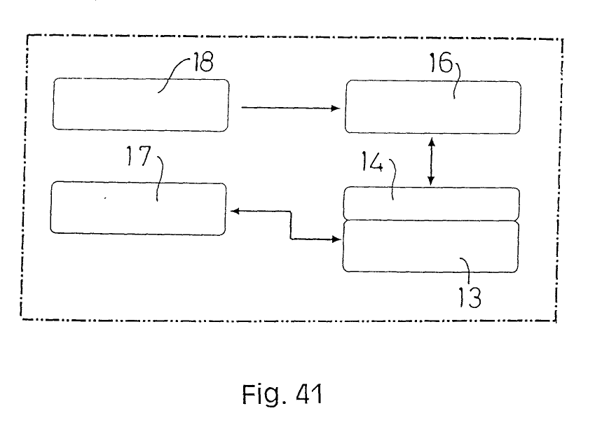

On the contrary, according to a further preferred embodiment of the method of the present invention, after having performed the cropping, the virtual reference background, FIG. 5B1, is now caused to backward slip or slide by two positions (FIG. 40), together with all the old backgrounds, with the exception of the Back5 background, which is now affected only by the BackGenerator.exe module, and accordingly by updated images, FIG. 40, which operation occurred, in the shown example, at 16.00 hours.

Later, for example at 16.15 hours, a subject overshooting operation for forming a card is performed. The image taken by the video camera is stored in the Back0 background, and the background interpolation ( ) function is started for summarily eliminating the subject areas, and then replacing them by those areas arranged at the same position, coming from the Back1 background. Thus, a reference virtual background, FIG. 5B1, is formed, in which the image portion not covered by the subject is updated at the overshooting time, whereas the portion “masked” by the subject must be recovered from a previous information (Back1˜Back4).

This virtual reference background, FIG. 5B1, constitutes the image which will be used by the cropping algorithm in order to discriminate the “subject” areas from the “background” areas.

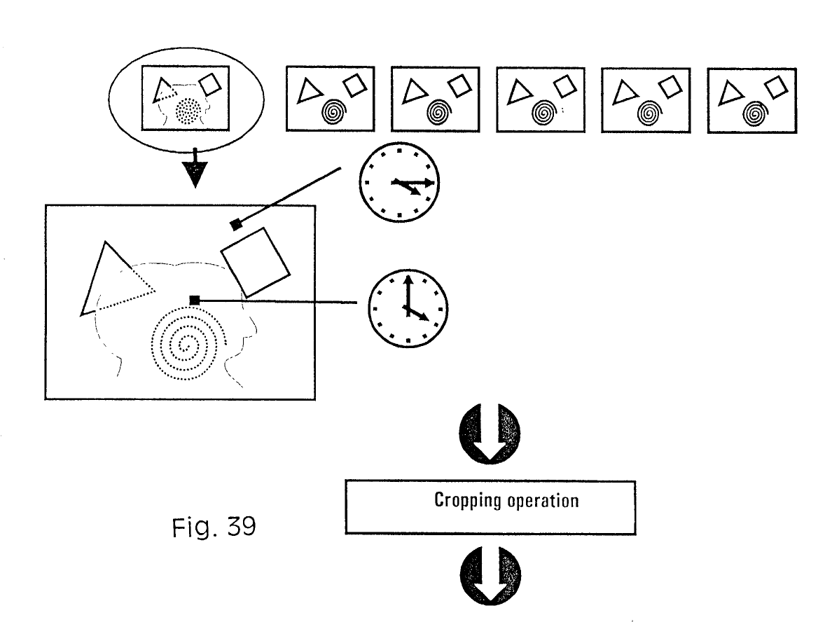

At the end of the cropping operation, FIG. 39, the Back4 image is eliminated, the Back3.bmp image is displaced into the Back4 image, the Back2 image is displaced into the Back3 image, and the reference virtual background, FIG. 5B1, (Back0), is displaced into the Back2 file.

As a last operation, the image present in Back5 is copied into Back1, thereby providing an updated information for the next interpolating-background operation, FIG. 40.

Broadening of the Formed Product Range

Two are the innovations or improvements introduced by the present invention into the software module representing the interface to the client, i.e. into the TheMask.exe module.

The first allows to take decisions related to the “card” and “greetings bill” products, as novel printed forms/patterns. According to the first embodiment of the proposed method the cards were printed by the so called “live printing” method, in which the image occupied the overall surface on the card. According to the invention, the user is now provided with the possibility of choosing the end product according to three patterns, for example: 1) with the prior live printed pattern or 2) with a frame shaped perimetrical edge or 3) with a frame shaped perimetrical edge and a caption at the bottom portion of the card, greetings bill or the like.

The second innovation is related to the so-called “stickers” and “visiting bills or cards”, in which, according to the invention, it is now possible to select if the photo pagination must be vertical (a commercial form) or horizontal, thereby admitting the presence of two persons simultaneously, for example a husband-wife pair, a friend set and so on.

Surveillance or Safety Application

As shown in great details in the above description, the two-image cropping technique has as the main principle of performing a comparative analysis of two images in order to establish their differences. By the above disclosed operation set, it is possible to identify different areas within an image being analyzed, FIG. 5C, with respect to a reference image, FIG. 5B.

In actual practice, this identifying mechanism related to the analyzed image variations can be used in principle, according to the invention, in all the fields in which it would be necessary to perform an image automatic analysis for different purposes.

By way of an example, an application of the two image cropping technique to the surveillance and safety field, susceptible to be easily fitted to dangerous area control embodiments, as well as access monitoring and so on embodiments, will be hereinafter disclosed.

The Prior Art Status

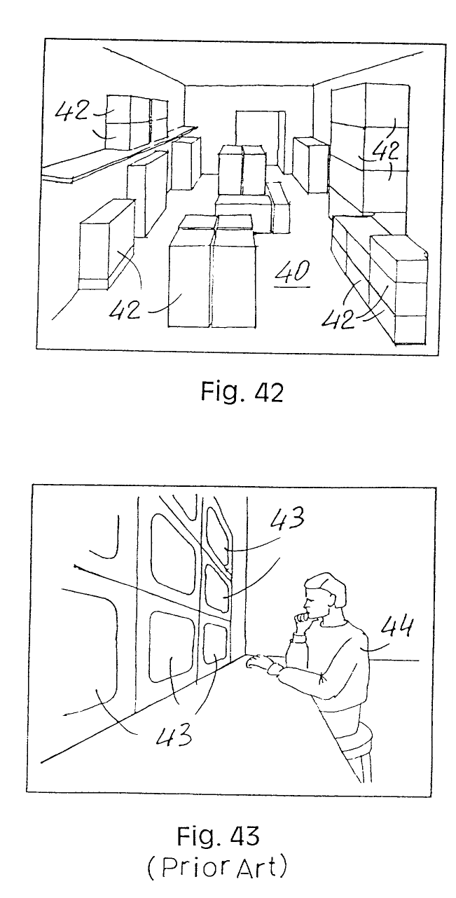

As an example, an area 40 such as the inside area of a goods store, monitored by one or more video-cameras, such as four video-cameras, not shown, FIG. 42, in which the case or box 42 number herein provided and the video-camera number, and related monitors 43, FIGS. 43, make difficult for a monitoring operator 44 to safely control the overall area 40, will be hereinafter disclosed. In such conditions, a possible intruder could not be easily detected, as he/she moves through the large boxes 42 by concealing therebehind. If the surveillance operator does not observe the related monitor at the intruder movement instant, then the surveillance operator will not be able of detecting the presence of the intruder who could operate in a rather free manner.

Improvement According to the Present Invention

On the contrary, a preferred embodiment of the surveillance and safety system according to the present invention is simplified in comparison to the above illustrated system embodiment and is adapted to analyze the image supplied by one or more video cameras and detect the moving intruder bodies, independently from the image complexity or the presence of objects through the area being monitored, such as furniture pieces, vehicles and the like.

The simplified surveillance and safety system comprises a PC 13, a video acquisition board 16, a monitor 17 and one or more video camera 18, for example of the type described in the previous application.

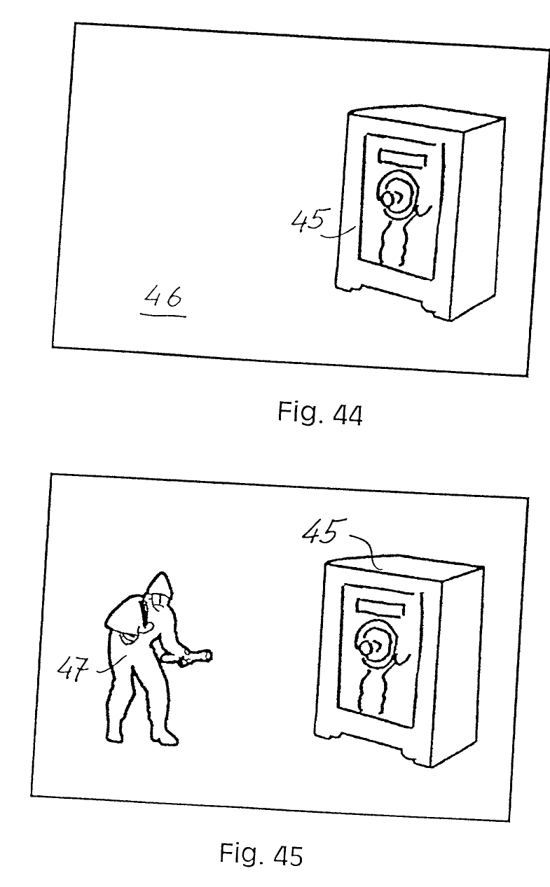

To achieve the desired end, a “sample image” is at first overshoot or “captured”, for example at the safety system energizing moment, and this “sample image” is stored in the system as a “reference background”, FIG. 44, for example as shown for a safe box 45 in a room 46.

It should be pointed out that, differently from the provisions for making cards, in the considered use it is not necessary to provide a “virtual reference background” by interpolating the previous images, since the final end is not that of providing a perfectly cropped image, but that of “capturing” with a maximum safety each possible variations related to a given time or image, for example at the system energizing time.

Under not-alarm conditions, i.e. in an intruder lacking condition, FIG. 44, the control monitor 43 (a single monitor being advantageously provided) of the video camera/video cameras, will provide the normal image taken through the environment 46, FIG. 44. With a cyclic frequency, for example of 3 seconds, the image supplied by the video camera, FIG. 45 is automatically compared with the reference image, FIG. 44.

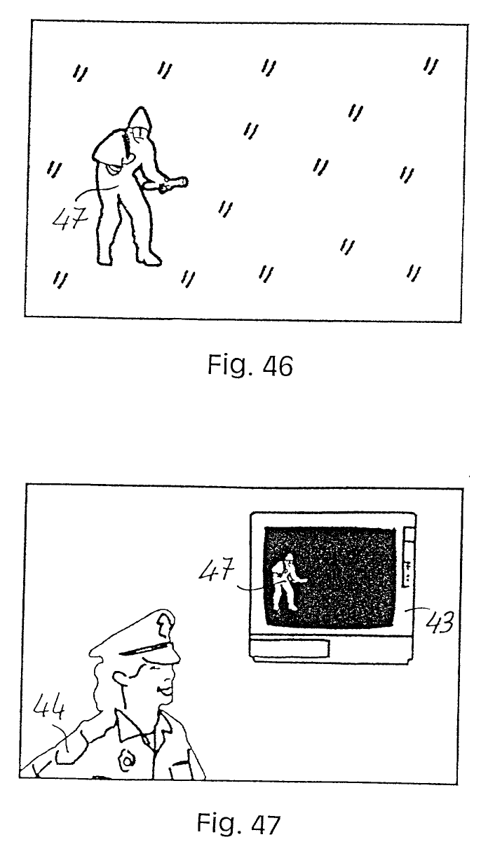

During the analyzing operation, all the shared and accordingly like areas are eliminated from the image, and it is controlled if are present remaining agglomerated pixels in more or less homogeneous areas, FIG. 46, i.e. areas which may represent a moving intruder person or body, not pertaining to the surveilled environment, FIG. 46. In an affirmative case, i.e. if an intruder person or body is present, the background of the control monitor 43 will assume a contrasting color pattern, for example a red color, and on the monitor the areas different or extraneous from the reference image, i.e., in the considered case, the presence of an intruder will be stored, FIG. 46.

Simultaneously, the image is stored, FIG. 46, together with the event hour and its place, for example the room access door area. In this case, the surveilling operator 44 can immediately display, in the control room, the image of the intruder 47.

Considerations on the Selection of the Reference Image Actuating Time (FIG. 44)

Ideally, the time for taking or “capturing” the reference image having the best safety characteristics, is the alarm actuating or energizing time.

However, cases can occur in which the taken image, FIG. 45, is not a static image, such as, for example, in an outside area case, in which the sun rise could trigger false alarms due to the formations of like-shadow zones and the displacements thereof. In order to overcome this excessive sensitivity of the warning mechanism, it would be sufficient to use, according to the invention, a reference image programmed updating, as shown in FIG. 44.

To that end an image storing cycle would be provided, to operate as a “reference image” for the cropped pattern, FIG. 44, with a typical time which can vary, for example, from 30 to 600 seconds, depending on the environment variation degree, and the area variation analysis will be performed on a “reference background”, FIG. 44, related to few minutes before the video-camera overshooting or taking time. Thus, the variations related to a time period in which the natural events, such as a light variation or the like, would not be sufficient to generate an alarm, but in which the presence of an intruder moving person or body could be detected and safely signaled, will be monitored.

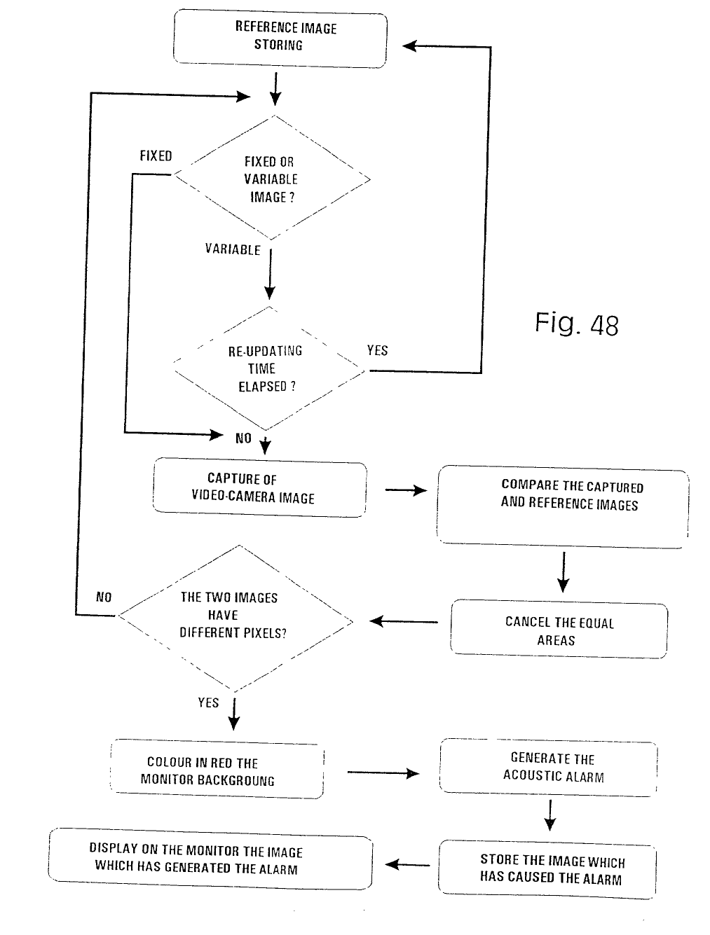

A detailed operation provided for such a safety application is shown in the flow chart of FIG. 48.

From this figure it should be easily apparent that, in a case of a fixed reference image, it would not be necessary to program the re-updating type whereas, in the case of a variable reference image, the re-updating time, will be selected depending on the environment conditions of the video-camera 18. For example, in a windowed store, i.e. a solar light receiving store, it would be required a re-updating time of, for example, 3 minutes, whereas a bank caveau would not generally require any re-updating of the reference image since it would not be subjected to solar light impinging radiations but exclusively to a constant artificial light or dark condition. From the above structural and functional-operation disclosure of the inventive systems and methods, it should be apparent that they fully achieve the above mentioned objects and aims, as well as the mentioned advantages. It should be apparent that one skilled in the electronic field could put in actual practice the teachings of the invention also by modifying in different manners the software and hardware portion, without departing from the invention scope and spirit as defined in the accompanying claims.

1. A system for making and digitally editing a composite image, for example a picture card, with a face of a user incorporated therein, comprising substantially, arranged in a housing casing (7):
a central computer (13),
a video acquisition panel (16),
a monitor (17),
a video-camera (18),
a banknote reading device (21),
printing means (19),
a lighting device (22),
a loudspeaker (23),
a presence sensor (26) adapted to detect the presence of persons or objects movable through the taking field of the video-camera (18),
signaling, communication or radio means (28, 29) arranged between the system and a shop keeper controlling the system, which can be power supplied by electric power and which operatively interact by operating sequences which can be controlled by software programs or modules;
wherein the video-camera (18) takes images with a free taking field, or with “multichromatic” and “dynamic” outer backgrounds, said system further comprising an outer PLC (24) operatively coupled to said central computer (13), banknote reading device (21), lighting device (22), presence sensor (26), and radio means (28, 29).

2. A system according to claim 1, characterized in that said system further comprises a visual signaling device, e.g. a directional LED (27), mounted on said housing casing (31) on a side of said monitor (17), in such a position that, as a user instinctively directs his/her face toward said energized directional LED, as attracted thereby, said user face will be properly seen by said video-camera (18) or displayed on said monitor (17), said direction LED (27) being coupled to said outer PLC (24), and in which a loudspeaker (23) is further mounted on a side of said LED (27), to operate as a directional loudspeaker for properly automatically locating said user face.

3. A system according to claim 1, characterized in that said printing means (19) comprise a single printer (19), said printer (19) being preferably adapted to be power supplied respectively by one of a plurality of power suppliers of different size printing paper media, and provided for different printed products, e.g. cards (3) and “special products” (FIGS. 23 to 26).

4. A system according to claim 1, characterized in that said printing means (19) comprise a plurality of printers (19), a number whereof corresponds to a number of said different printing paper media for a different products which can be printed by said system, e.g. said cards (3) and “special products” (FIGS. 23 to 26).

5. A system according to claim 1, characterized in that said system further comprises a functional-operating architecture comprising the following operating software modules or programs cooperating with one another and controlling the associated components of the system (13, 16, 17, 18, 19, 20, 21, 22, 23, 24, 26, 27) as follows:
a Module A, for example (TheMask.exe), or a user-system interface, displaying on said screen (17) different options to be selected by the user, communicating to the system the selections performed by the user and supplying corresponding graphics animations;
a Module B, e.g. (Core.exe), which, through said video acquisition panel (16), captures the images generated by the video-camera (18), and converts the input video signal by transforming it into an ordered sequence of pixel constituting the mathematics expression of all the geometric patterns present in the considered image, said software Module B extrapolating the image of the “subject” (6) from the “background-subject assembly” (FIG. 5C) and locating said image on the “view” (4) selected by the user, said extrapolation being performed by different analyses of the different chromatic equivalent area existing between a “first image”, constituting a “reference background” (FIG. 5B1) and a “second image” formed by the “background-subject assembly” (FIG. 5C) as taken by the video-camera (18) with a free taking field;
a Module C1;C2, for example (BackIni.exe; BackBuild.exe.), which, if the presence sensor (26) does not detect movements of objects in the taking field of the camera (18) within a presettable time, causes said camera (18) to take an encompassing outer environment or “taken background” (FIG. 5B),
a Module D, for example (Mailer.exe), which sends all the messages to the different components of the system, and, more specifically, between the user interface, Module A, “TheMask.exe”, and the module B, “Core.exe”, during the acquisition by the video-camera (18), and with the outer PLC (24) for controlling the lighting device (22) and the operations of the banknote reading device (21) and with the printer (19), thereby controlling a proper printing process, all the message exchange between the Module D, “Mailer.exe” and the Module B, “Core.exe” occurring through the Registry of the computer (13), the message flow being a bidirectional message flow,
a Module E, for example (Golem.bin), which is arranged in the outer PLC (24) and controls the “timers” and presence sensor (23) actuating and allowing the taking of the “taken backgrounds”, turning said lighting device (22) on as said “subject” is taken, operating said loudspeaker (23) and communicating to the computer (13) an amount introduced into the banknote reading device (21).

6. A system according to claim 2, characterized in that said directional “LED” (27), is operatively controlled by the module D, or Mailer.exe and by the outer PLC (24).

7. A method for making and digitally editing a composite image, for example a card with a face of a user incorporated therein, by a system according to claim 1, comprising the following steps, actuated by said user and performed by the components (13, 16, 17, 18, 19, 21, 22, 23, 24, 26, 27) and software modules (A, B, C1, C2, D and E) of the system:
a) selecting, by said user, a “view” (4) among a plurality of prestored “views” and reproducing said view on said screen (17),
b) selecting, by said user, an insertion position for said “subject” (6) on the “view”, among a plurality of different positions shown on said screen (17),
c) performing by the camera (18), controlled by said user, a taking step d) for taking a “background-subject assembly” thereon a following cropping step e) for cropping the “subject” will be then performed, characterized in that:
in said step d) for taking the “background-subject assembly” the taken background is an instantaneous real background of the free taking field of the video-camera (18), or a “multichromatic” and “dynamic” background,
in that said cropping step e) is carried out by processing two images, i.e. a “first image”, which is constituted by the image taken by said video-camera as said system is turned on, or by the “background taken without the subject”, which, for improving said cropping step, is virtually processed to provide a “reference background”, and a “second image”, formed by said “background-subject assembly” of said step d),
that said method further comprises the following steps, in part known per se:
a refining or trimming step f) for trimming the contour of the “subject” (6) insulated by the “background” thereof;
a subject translating step g) wherein the cropped subject (6) is translated to a preselected region of the “view” (4), said subject (6) being embedded in said “view” (4) by a physical replacement, pixel by pixel, of the pixels of said preset region of said “view” (4) with said pixel of said “subject” (6),
and an optional caption or wording insertion step h), for inserting captions or wordings (32) into said composite image (3, in FIG. 3), and
a following printing step i) for printing said composite card (3), and
in that, as the system is turned on, a self-updating cyclic step j) is carried out for self-updating said “taken background”, said self-updating cyclic step j) having a duration of substantially 180 sec, and in that a shorter cyclic attention step h) for the presence sensor (26) is furthermore carried out, said cyclic attention step having, for example, a duration of 30 sec, and wherein, if the free shooting field of said video-camera (18) is traversed by a person, an animal or an object—with a consequent introduction of their “new” image with respect to the “taken background”, then the presence sensor (26) attention cycle is reinitialized.

8. A method according to claim 7, characterized in that said step j) for self-updating said “reference background” (FIG. 5B1) is carried out in a plurality of working files (back0, back1, back2, back3, back4, back5), which form a “time queue” of said working store, wherein the previous “reference background” image present in the first working file (back0) is displaced to the following working file (back1) and so on from file to file progressively with a reverse displacement (from back1 to back2; from back2 to back3; from back3 to back4; from back4 to back5), wherein, moreover, the “reference background” image held in the last working file (back5) is suppressed (FIGS. 11 to 14).

9. A method according to claims 7 and 8, characterized in that, for providing the “first image” or virtual, valid “reference background” used in the following cropping two-image step e), in said working file Back0) said respective “taken background” (FIG. 5B) is stored, wherein
between the image held in the first working file (Back0) and the preceding images held in the other working files (from Back1 to Back5), the chromatic similitudes of the pixels arranged at the same locations are searched and, if for each pixel of the working file (Back0) a corresponding twin pixel is found in at least two images of the previous working files (from Back1 to Back 5), then said pixel in said first working file (Back0) is held as valid, otherwise said pixel being replaced (in Back0) by the latest twin pixel of the “reference background”, i.e. of the image in the working file (Back1) (FIG. 12).

10. A method according to claim 7, characterized in that said “reference background” or “first image” is updated, as the “background-subject assembly”, for the area of the background not covered by the “subject”, is taken, while for the part covered by the “subject” it is recovered from the latest “reference background”, i.e. from the image in the working file (Back1) (FIGS. 13, 13A).

11. A method according to claim 7, characterized in that, for carrying out said cropping step e) the following steps are performed:
a step l) of displacing said pixels from the “background” subject assembly” (FIGS. 5C),
a step m) of displacing said pixels from said “reference background” (FIG. 5B1),
a step n) of carrying out a first differential analysis on a chromatic base,
a step o) of carrying out a second differential analysis, also on a chromatic base,
a step p) of boolean comparing for determining pixels to be preserved and pixels to be suppressed as present in two different working arrays, and
a step q) of carrying out a third differential analysis on a colorimetric base.

12. A method according to claim 9, characterized in that in said step l), said pixels of said “background-subject assembly” (FIG. 5C) are shifted from the acquisition panel (16) buffer to a series of working arrays in a RAM memory, called ForeR, ForeG, ForeB, ForeN and ForeZ, now holding the foreground data, wherein the arrays ForeR, ForeG and ForeB hold therein the values of the chromatic components red, green and blue of the individual pixels, the array ForeN holds the markings for attributing said pixels of said “background-subject assembly” (FIG. 5C), respectively to said “subject” or to said “background”, wherein the array ForeZ will operate as a “tank” for temporarily transit or data related to the individual pixels.

13. A method according to claim 11, characterized in that the step m) is carried out like the step n), wherein said pixels of said virtual “reference background” or “first image” (FIG. 5B1) are shifted to a series of working arrays called BackR, BackG and BackB, which hold now therein the data of the “second image” (FIG. 5C, Back0) called “background”.

14. A method according to claim 11, characterized in that said first differential analysis step n) is based on the pixel isoareas among the arrays Fore and the arrays Back and is a cyclic function which can be automatically repeated up to a full analysis of all of the image pixels, wherein said analysis consists of collecting the foreground data in isoareas in which said pixels have a chromatic similitude, by analyzing the chromatic similitudes of adjoining pixels, wherein said analysis is spread in all directions the limits whereof are defined by a chromatic offset exceeding the parameters of a preset tolerance, wherein to the pixels of the isoarea a working color is attributed which is stored in a working array called “PointerFore”, and corresponding to the average of the chromatic values of said isoarea, wherein the shape and position of the thus defined isoarea Fore (T1, FIG. 15) is “projected” on the image present in the arrays Back (T2, FIG. 15), and the average color obtained by the projection of the shape of the isoarea Fore on the array Back is stored in the working array called “PointerBack”, wherein, moreover, as a result of this analysis based on a quantization of the image colors, two new working arrays “PointerFore” and “PointerBack”, respectively holding herein a pair of the “background-subject assembly” or “second image” (FIG. 5C) and a pair of the virtual “reference background” or “first image” (FIG. 5B1) formed by the set of the isoareas identical for shape and position, but “leveled” or smoothed by the average of the colors of the respective sources are obtained.

15. A method according to claim 11, characterized in that said second differential analysis step 0) is based on chromatic isoareas of the arrays holding the image Fore and the arrays holding the image Back, wherein this function is operatively analogous to that of said step n), i.e. it extends in all directions, but with the difference that the isoareas are now defined independently both for the arrays Fore and for the arrays Back, the features consisting of the size and location of the isoarea, being compared in an independent manner for the two arrays, wherein, after the definition of said isoareas, if the size difference of the two isoareas Fore and Back is less than a preset value, for example 10%, then said isoareas are considered as similar since, being said isoareas present in both images, i.e. in the image “Background” and in the image “Foreground”, then said areas pertain to the respective “background” but not to the “subject” of the “background-subject assembly” image (FIG. 5C), wherein if a similitude is found, both said isoareas are forcibly recolored by a pure white color in both the arrays “PointerFore” and “PointerBack”, thereby providing a further improvement of the result of the first differential analysis of said step n), those areas not affected by said first chromatic analysis being suppressed.

16. A method according to claim 11, characterized in that in said comparing step p) a boolean comparing between the pixel which are present in said arrays “PointerFore” and “PointerBack” is carried out, wherein, for each pixel, the colorimetric values are read-out and, if said chromatic differences are contained with a given settable tolerance, then the pixel is marked in the array ForeN as “background” or as a supprimible pixel, otherwise said pixel being marked as a “subject” pixel, i.e. as a pixel to be preserved, wherein the information for each individual pixel related to the pertaining of said pixel to one of the two “background” or “subject” sets of said “background-subject assembly” or “second image” (FIG. 5C) is stored in the array ForeN.

17. A method according to claim 11, characterized in that the third differential analysis of the step q) is based on individual pixels between the arrays Fore and the arrays Back, wherein the image pixels present in said array Fore are individually compared to the “twin” pixel present in the array Back by a comparing based on a chromatic similitude on the single pixel pair, and on an offset of the color delta from the adjoining pixel, wherein, if the differences are held within a given settable tolerance range, then the two pixels are evaluated as suppressible, since they both pertain to the “background” of the “background-subject assembly” or “second image” (FIG. 5C), and accordingly being marked as “background” inside said array ForeN, whereas, in a contrary case, no marking variation of the array ForeN is performed, thereby obtaining an image reflecting the cropped “subject” (6), with a provision of an amount of loose, insulated pixels, cutting corners and so on which, for an optimum “cropping” quality can be subjected to a further end cleaning/integrating multiple function processing.

18. A method according to claim 17, characterized in that in said multiple function end processing of cleaning/integrating said image, are provided:
two functions r) and r1) for suppressing “orphan” or insulated pixels,
two functions s) and s1) for cleaning erroneous areas,
a “trimming” function for trimming or filing the edges of the subject (6) and
a soft function t) for harmonizing said subject (6) edges, wherein, in addition to a continuing of the method for making composite cards (3), it is likewise possible to alternately continue the method for making said “special products”.

19. A method according to claim 18, characterized in that in the function r), said array Fore is analyzed and are searched the insulated pixels marked as pertaining to said “subject” and encompassed by pixels marked as pertaining to said “background”, or by another pixel marked as “subject”, wherein the pixels having these features are marked as pixels pertaining to said “background” and, accordingly, as suppressible.

20. A method according to claim 18, characterized in that the function r1) is carried out as the function r), with the difference that are herein searched “background” pixels encompassed by “subject” pixels, wherein as this occurs, the function will close the “holes” in the “subject” by modifying the marking from “background” to “subject”.

21. A method according to claim 18, characterized in that in the step s), in said “subject” areas are searched adjoining pixel sets with a background marking to search their size, wherein, if said size is less than a given threshold, for example 2000 adjoining pixels, then the area is marked as “subject”, wherein the searching method for establishing said area size is the all-direction searching method provided for said step n), and wherein all the image pixels are analyzed and the continuity of the adjoining regions of “background” pixels and “subject” pixels is verified.

22. A method according to claim 18, characterized in that the step s1) is reversely performed from the step s), since said step s1) searches “subject” areas encompassed by “background” areas.

23. A method according to claim 18, characterized in that said “filing” or trimming function t) allows to suppress “spike” pixels, i.e. those pixels projecting from the edges of the subject (6), wherein this function is a recursive function and is performed, for example, three times.

24. A method according to claims 18 to 23, characterized in that the function soft u) is performed for searching, for all the individual pixels of the “subject”, the actual distance from the edge of said “subject” and, if said distance varies from 0 to 8 pixels, then to the pixel is applied a value defining the clearness of said pixel and, more specifically, with a strength which is reversely proportional to the distance of said edge, wherein said values are not immediately used, but interpreted at a subsequent time in a following merging step v) for merging the cropped “subject” (6) image and the preset view (4) image.

25. A method according to claims 18 to 24, characterized in that, in continuing said method for making composite cards (1), at the end of said analysis/comparing and multiple-function final processing steps, in said merging step v) the surviving pixels of the image Fore, i.e. of said “subject” (6) are embedded by a physical replacement in the view (4) image, and that an harmonizing function w) for harmonizing the subject (6) edges with the adjoining pixels is moreover provided.

26. A method according to claims 25, characterized in that in said harmonizing function w) for harmonizing said pixels along the subject (6) edges included in a distance of 0 to 8 pixels from the “subject” edge, to said pixel the following formula for each of the chromatic components of the “subject” pixels being applied:
Cₜ={Cₛ*K+Cₚ(1−K)}
where Ct is the value of the red, green or blue chromatic components, t is the value obtained by the applied clearness correction, s is the “subject” pixel, p is a “view” pixel and K is a constant derived from the formula:
K−(Dᵣ+1)/Dₜ
where D is the unit distance expressed in pixels, r is the distance of the involved pixel from the edge, and t is the total distance affected by the clearness.

27. A method according to claims 7 and 24, characterized in that after said “subject” (6) and “view” merging step v), an adding step x) for adding wordings or a caption (32) to the view (4) is optionally carried out, wherein said step x) adding said wordings (32) to said view (4) is analogous to said merging step v), and wherein, for defining the writing regions with respect to the non affected “background” regions, there is used the known “chromakey” method, using, for example, as a discriminating color, the pure green.

28. A method according to claim 7, characterized in that, after having formed the composite image (3), said image is saved on a disc, all the working arrays are disrupted, to the system the store assigned for managing the objects of the software operating modules (A, B, C1, C2, D, E) is recovered, and the 1-value is written in the system registry at the “Mainstreet/print” location, constituting the signal for the module D, “Postino.exe”, that the file is ready, and the composite image (3) can be printed.

29. A method according to claim 7 and one or more of claims 8 to 24, for additionally making greeting cards, characterized in that as a “view” is introduced a view suitable for a greeting card, which has been prestored and can be selected by the user among a plurality of other prestored uses, wherein a caption or overlay according to the step h) of claims 7 and 27 can be added, wherein, at the end of the step soft u) of claim 24, on said screen a display showing the photo of the face of the user inserted into the preselected “view”, as well as the overlay also preselected by the user are displayed.

30. A method according to claim 7 and one or more of claims 9 to 24 for additionally making photo-cards and stickers, characterized in that the software operating module B, “Core.exe”, saves an image in which the “subject” has been put on a “view” as a white, or other suitable color background, wherein the post-processing module F provides a form in which the printing format forming images are arranged, for example by providing 16 small images for said stickers or 4 or 6 larger images for said photo-cards, wherein, after forming the composite pattern composition, said composite pattern is sent to said printer.

31. A method according to claim 7 and one or more of claims 8 to 24 for making visiting cards, characterized in that, likewise to the method for making said greeting cards, a form for the layout preselected among a range of prestored layout is provided, wherein inside said layout there are arranged an image, which is the photo processed by the module B, “Core.exe”, and a plurality of text cells representing the “vessels” provided for receiving the text keyed by the user, for example by using the virtual keypad on the touch screen (17), thereby, by touching one of the text fields, the keyed characters will fill in said field, wherein, to edit a further field, it said further field is simply touched on said screen, thereby addressing the input of said virtual keypad toward said other field, wherein, moreover, by pressing a confirmation field on the virtual keypad of the monitor (17), the layout will be duplicated into a series of copies, for example three copies, on another form holding the actual print size therein, and then said new form being sent to said printer.

32. A method according to one or more of claims 7 to 31, for making composite cards or special products, characterized in that said method further comprises the step of sending said composite cards or special products to a receiving party through the internet, wherein the end bitmap is reduced to a size suitable for display on said screen and being converted into a JPG format, a form allowing to input data of the sending party, of the receiving party, as well as a short accompanying text, and then the assembly being integrated in a HTML codified page and sent onto the net by a modem and telephone, after having introduced into the casher the required money or amount for transmitting on internet, and as displayed on the screen.

33. A system according to the preamble of claim 1, characterized in that said presence sensor is an optical presence sensor in the form of a software operating through the video-camera (18) of the system.

34. A system according to claim 33, characterized in that said system further comprises a functional-operating architecture comprising the following operating software modules or programs cooperating with one another and controlling the associated components of the system (13, 16, 17, 18, 19, 20, 21, 22, 23, 24, 27) as follows:
a Module A, for example (TheMask.exe), or a user-system interface, displaying on said screen (17) different options to be selected by the user, communicating to the system the selections performed by the user and supplying corresponding graphics animations;
a Module B, e.g. (Core.exe), which, through said video acquisition panel (16), captures the images generated by the video-camera (18), and converts the input video signal by transforming it into an ordered sequence of pixel constituting the mathematics expression of all the geometric patterns present in the considered image, said software Module B extrapolating the image of the “subject” (6) from the “background-subject assembly” (FIG. 5C) and locating said image on the “view” (4) selected by the user, said extrapolation being performed by different analyses of the different chromatic equivalent area existing between a “first image”, constituting a “reference background” (FIG. 5B1) and a “second image” formed by the “background-subject assembly” (FIG. 5C) as taken by the video-camera (18) with a free taking field;
a Module D, for example (Mailer.exe), which sends all the messages to the different components of the system, and, more specifically, between the user interface, Module A, “TheMask.exe”, and the module B, “Core.exe”, during the acquisition by the video-camera (18), and with the outer PLC (24) for controlling the lighting device (22) and the operations of the banknote reading device (21) and with the printer (19), thereby controlling a proper printing process, all the message exchange between the Module D, “Mailer.exe” and the Module B, “Core.exe” occurring through the Registry of the computer (13), the message flow being a bidirectional message flow,
a Module E, for example (Golem.bin), which is arranged in the outer PLC (24) and turns said lighting device (22) on as said “subject” is taken, and communicates to the computer (13) an amount introduced into the banknote reading device (21), wherein the control of the “timers” and the presence sensor which actuate and allow the taking of the “taken backgrounds” is preferably provided inside the modul “Mailer.exe”, and wherein the loudspeaker (23) is operated by the central computer (13) characterized in that it further comprises
a Module C, for example (BackGenerator.exe) which on one hand replaces both modules (C1 and C2) BackIni.exe and BackBuild.exe of the previous application and on the other hand through the video-camera (18) is able to accurately discriminate the most important features related to the unchanged two-image cropping algorithm which is therefore a presence sensor without any physical reality.

35. A method according to claim 7, characterized in that for verifying if disturbing persons or bodies are arranged before the system an optical presence sensor operating through the system video-camera and a dedicated software is used, and in that it comprises the following steps:
a) two overshootings or images are remotely taken, for example, at 1 second from one another, by using the same video-camera of the system,
b) said two images are chromatically compared with respect to their pixels, i.e. each individual pixel of the first overshooting or image is measured and compared with the pixel at the same position of the second image,
c) if the chromatic difference is less than a preset given tolerance, then said pixel is judged as the same, otherwise said pixel being marked as different,
d) if, within the second image, the different pixels are less than a given tolerance (for example 200, with reference to a total pixel number of over 442,000 of the whole image), then it is judged that no variations of the two images have occurred and that, accordingly, before the video camera no persons or disturbing bodies or elements, such as casted shadows or light reflections are present,
e) if no disturbing person or element is arranged before the video camera, the system will switch the illuminating system on and will take two further images, spaced by 1 second from one another,
f) said two further images are also analyzed like as provided for in steps b), c) and d) to verify if, in the meanwhile, disturbing person or elements have entered the visual field of the video-amera,
g) in the case that a first and a second images are found equal, i.e. in the absence of disturbing persons or elements, the system switches the illuminating system off and stores the second images in the Back0 to Back5 files (FIG. 10), i.e. the sequence of the reference files which will be used for building the “virtual reference background” (FIG. 5B1), whereas
h) in the case that a first and a second images are found different, i.e. in the presence of disturbing persons or elements, then the system will continue to take overshootings or images, at a distance of 1 second from one another, while performing a comparing thereof as provided for in steps b), c) and d) untill a pair of or images is found without a difference greater than the provided tolerance (for example 200),
i) if, after a number of attempts, no “reference background” can be built, then the system will provide a signal, such as an acoustic signal or warning signal, and preferably open a window on the monitor showing a short message asking the persons near the video-camera to move away for allowing the system to properly operate,
j) as a subsequent pair of equal first and second images is detected, the system will switch off the lights, and the video-screen will preferably display a greetings message, thereby allowing the system to complete the last image storing operations.

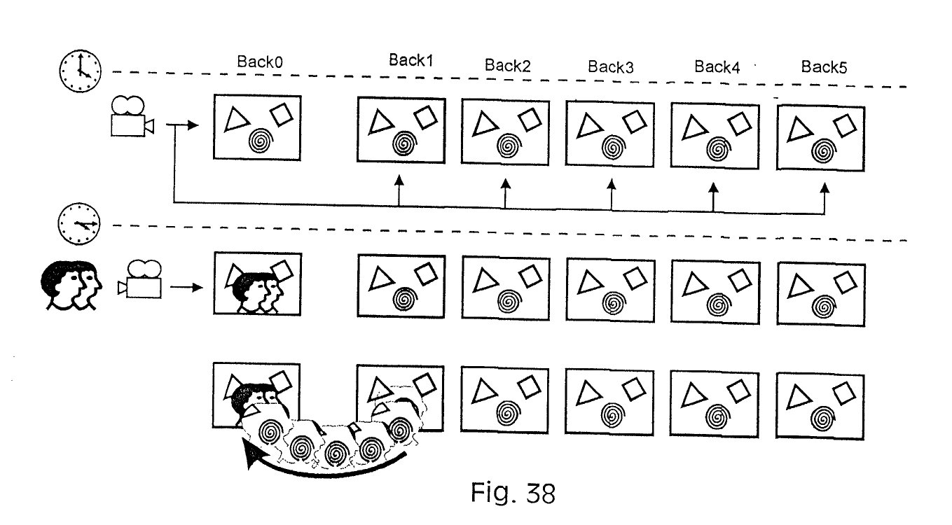

36. A method according to claim 35, characterized in that it comprises the following steps
k) after having performed the cropping, the virtual reference background (FIG. 5B1), is now caused to backward slip or slide by two positions (FIG. 40), together with all the old backgrounds, with the exception of the Back5 background, which is now affected only by the BackGenerator.exe module, and accordingly by updated images, which operation occurred at a certain time, for example at 16.00 hours (FIG. 38),
l) later, for example at 16.15 hours, a subject overshooting operation for forming a card is performed and the image taken by the video camera is stored in the Back0 background, and the background interpolation ( ) function is started which will summarily eliminate the subject areas, and then replace them by those areas arranged at the same position, coming from the Back1 background, whereby a reference virtual background (FIG. 5B1) is formed, in which the image portion not covered by the subject is updated at the overshooting time, whereas the portion “masked” by the subject must be recovered from a previous information (Back1˜Back4), whereby said virtual reference background (FIG. 5B1) constitutes the image which will be used by the cropping algorithm in order to discriminate the “subject” areas from the “background” areas,
m) at the end of the cropping operation (FIG. 38), the Back4 image is eliminated, the Back3.bmp image is displaced into the Back4 image, the Back2 image is displaced into the Back3 image, and the reference virtual background (FIG. 5B1), (Back0), is displaced into the Back2 file, whereby
n) as a last operation, the image present in Back5 is copied into Back1, thereby providing an updated information for the next interpolating-background operation (FIG. 40).

37. A method according to claims 35 and 36, characterized in that into the TheMask.exe module is provided for the client the possibility to take decisions related to the “card” and “greetings bill” products as novel printed format, that is of choosing for the end product among three patterns, for example among 1) an end product having the traditional so called “live printing” format, 2) an end product with a frame shaped perimetrical edge, or 3) an end product with a frame shaped perimetrical edge and a caption at the bottom portion of the card, greetings bill or the like.

38. A method according to claims 35 and 36, characterized in that into the TheMask.exe module is provided for the client the possibility as to the so-called “stickers” and “visiting bills or cards” to select if the photo pagination must be vertical (the commercial form) or horizontal.

39. A system of the type disclosed in claim 33, characterized in that it is used in the surveillance and safety field, is simplified as stated in the following and comprises, arranged in a housing casing:
a central computer (13),
a video acquisition board (16),
a monitor (17),
a video-camera (18),
which can be power supplied by electric power and which operatively interact by operating sequences which can be controlled by software programs or modules of the type disclosed in claim 34, wherein the video-camera (18) takes images with a free taking field, or with “multichromatic” and “dynamic” outer backgrounds, wherein said system further comprises an optical presence sensor operating through the system video-camera (18) and software.

40. A method of the type disclosed in claims 35 and 36, characterized in that it is used in the surveillance and security field, is simplified as stated in the following and comprises the following steps
A) a “sample image” is at first overshoot or “captured”, for example at the safety system energizing moment,
B) said “sample image” is stored in the system as a “reference background” (FIG. 44),
C) under not-alarm conditions, i.e. in an intruder lacking condition, FIG. 44, the control monitor 43 (a single monitor being advantageously provided) of the video-camera/video-cameras, will provide the normal image taken through the environment, (FIG. 44), whereby with a cyclic frequency, for example of 3 seconds, the image supplied by the video-camera (FIG. 45) is automatically compared with the reference image (FIG. 44),
D) during the analyzing operation, all the shared and accordingly like areas are eliminated from the image, and it is controlled if are present remaining agglomerated pixels in more or less homogeneous areas (FIG. 46) i.e. areas which may represent a moving intruder person or body, not pertaining to the surveilled environment,
E) in affirmative case, i.e. if an intruder person or body is present, the background of the control monitor will preferably assume a contrasting color pattern, for example a red color, and on the monitor the areas different or extraneous from the reference image, for example the image of an intruder, will be stored, and
F) simultaneously, the image is stored together with the event hour and its place, for example the room access door area, so that the surveilling operator can immediately display the image of the intruder.

41. A system according to claim 33, characterized in that the PLC is provided as an inner component.

42. Composite cards, greeting cards, photo-cards and stickers, visiting cards and the like, characterized in that they are made and printed by a systems and method according to one or more of the claims 1 to 38.
